(19) United States
(12) Patent Application Publication
(10) Pub. No.: US 2026/0121335 A1
(43) Pub. Date: Apr. 30, 2026

(54) BOARD CASE, CARD EDGE BOARD DEVICE, AND CARD EDGE CONNECTION STRUCTURE

(71) Applicant: HIROSE ELECTRIC CO., LTD., Kanagawa (JP)

(72) Inventors: Akira NAGAMINE, Kanagawa (JP); Isao TASHIRO, Kanagawa (JP)

(21) Appl. No.: 19/371,632

(22) Filed: Oct. 28, 2025

(30) Foreign Application Priority Data
Oct. 30, 2024 (JP) 2024-190351

(51) Int. Cl. H01R 13/512; H01R 12/72

(52) U.S. Cl. CPC H01R 13/512; H01R 12/721

(57) ABSTRACT

Provided is a board case, including: a case body forming a housing space wherein a board body is housable; and a fitting tubular body, the case body includes one surface having a board passing opening, the board passing opening is formed such that the board body is passable through the board passing opening in a posture of a principal surface being parallel to the one surface, and the board body is supported by the case body while maintaining the posture at a time of passage through the board passing opening, and part of the fitting tubular body located in the housing space has a contact passing opening formed such that a contact of the board body is passable therethrough, and the contact is disposed in the fitting space as the part of the fitting tubular body while maintaining a posture at a time of passage through the contact passing opening.

### CROSS-REFERENCE TO RELATED APPLICATION

This application claims priority from Japanese Patent Application No. 2024-190351 filed with the Japan Patent Office on October 30, 2024, the entire content of which is hereby incorporated by reference.

### BACKGROUND

### 1. Technical Field

The present disclosure relates to a board case, a card edge board device, and a card edge connection structure.

### 2. Related Art

There has been known a case housing a board having a contact at an end portion (for example, see JP-A-2017-117914). The case of JP-A-2017-117914 includes a first housing opened in the upper surface, a tubular second housing opened in the side surface, and a tubular communication portion causing both these housings to communicate with each other. In a case where the board is housed in the case, an elastic member is attached to the board, and the end portion (contact) of the board enters the communication portion in a state of the board being in an inclined posture. At this time, while the elastic member is contacting an abutting portion provided at the communication portion, the contact enters the second housing. Thereafter, the posture of the board is deformed to a horizontal posture, and in this manner, the board is housed in the first housing.

### SUMMARY

A board case according to the present disclosure is a board case for housing a card edge board having a contact at an end portion of a board body, the board case including: a case body forming a housing space in which the board body is housable; and a fitting tubular body forming a fitting space in which the contact of the card edge board is housable and a card edge connector connected to the card edge board is fittable, in which the fitting tubular body is formed in a tubular shape having an opening opened along a direction parallel to a principal surface of the card edge board housed in the board case and extending outward of an inside of the housing space, the case body is formed in a box shape including one surface having a board passing opening, the board passing opening is formed such that when the card edge board is housed in the board case, the board body is passable through the board passing opening in a posture of the principal surface being parallel to the one surface, and the board body is supported by the case body while maintaining the posture at a time of passage through the board passing opening, and part of the fitting tubular body located in the housing space has a contact passing opening formed such that the contact is passable therethrough, and the contact is disposed in the fitting space as the part of the fitting tubular body while maintaining a posture at a time of passage through the contact passing opening.

### BRIEF DESCRIPTION OF THE DRAWINGS

FIG. 1 is a perspective view showing a card edge connection structure according to a first embodiment of the present disclosure;

FIG. 2 is a perspective view showing the card edge connection structure according to the first embodiment of the present disclosure in a state of a card edge connector being connected to a card edge board device;

FIG. 3 is an exploded perspective view showing the card edge board device according to the first embodiment of the present disclosure;

FIG. 4 is a perspective view showing a board case according to the first embodiment of the present disclosure;

FIG. 5 is a sectional view showing the card edge board device according to the first embodiment of the present disclosure;

FIG. 6 is an exploded perspective view showing the card edge connector of the card edge connection structure according to the first embodiment of the present disclosure;

FIG. 7 is a plan view showing the card edge connector of the card edge connection structure according to the first embodiment of the present disclosure;

FIG. 8 is a sectional view showing the card edge connection structure (before connection) according to the first embodiment of the present disclosure;

FIG. 9 is a sectional view showing the card edge connection structure (after connection) according to the first embodiment of the present disclosure;

FIG. 10 is an exploded perspective view showing a card edge board device according to a second embodiment of the present disclosure;

FIG. 11A is an exploded sectional view showing the card edge board device according to the second embodiment of the present disclosure;

FIG. 11B is a sectional view showing the card edge board device according to the second embodiment of the present disclosure;

FIG. 12 is an exploded perspective view showing a card edge connector of a card edge connection structure according to the second embodiment of the present disclosure;

FIG. 13 is a sectional view showing the card edge connection structure (before connection) according to the second embodiment of the present disclosure;

FIG. 14 is a sectional view showing the card edge connection structure (after connection) according to the second embodiment of the present disclosure;

FIG. 15A is a front view schematically showing part of a card edge connector of a card edge connection structure according to a modification of the second embodiment of the present disclosure;

FIG. 15B is a perspective view showing a card edge board of a card edge board device according to the modification of the second embodiment of the present disclosure;

FIG. 16 is an exploded perspective view showing a card edge board device according to a third embodiment of the present disclosure;

FIG. 17A is an exploded sectional view showing the card edge board device according to the third embodiment of the present disclosure;

FIG. 17B is a sectional view showing the card edge board device according to the third embodiment of the present disclosure; and

FIG. 18 is an exploded perspective view schematically showing a card edge board device of a card edge connection structure according to a fourth embodiment of the present disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, in the case of JP-A-2017-117914 described above, after the board has diagonally entered the communication portion and the second housing, the posture of the board needs to be changed, and for this reason, there is a problem that it is difficult to house the board in the case.

In view of the above-described situation, one object of the present disclosure is to provide a board case, a card edge board device, and a card edge connection structure capable of easily housing a card edge board.

(1) A board case according to the present disclosure is a board case for housing a card edge board having a contact at an end portion of a board body, the board case including: a case body forming a housing space in which the board body is housable; and a fitting tubular body forming a fitting space in which the contact of the card edge board is housable and a card edge connector connected to the card edge board is fittable, in which the fitting tubular body is formed in a tubular shape having an opening opened along a direction parallel to a principal surface of the card edge board housed in the board case and extending outward of an inside of the housing space, the case body is formed in a box shape including one surface having a board passing opening, the board passing opening is formed such that when the card edge board is housed in the board case, the board body is passable through the board passing opening in a posture of the principal surface being parallel to the one surface, and the board body is supported by the case body while maintaining the posture at a time of passage through the board passing opening, and part of the fitting tubular body located in the housing space has a contact passing opening formed such that the contact is passable therethrough, and the contact is disposed in the fitting space as the part of the fitting tubular body while maintaining a posture at a time of passage through the contact passing opening.

In the disclosure of (1), the board passing opening is opened in the one surface of the case body. The board passing opening is formed such that when the card edge board is housed in the board case, the board body is passable through the board passing opening in the posture parallel to the one surface of the case body having the board passing opening. The board body passes through the board passing opening in the posture parallel to the one surface of the case body having the board passing opening, enters the case body, and is supported (housed) by the case body while maintaining the posture at the time of passage through the board passing opening. In part of the fitting tubular body located in the housing space of the case body, the contact passing opening formed such that the contact passes therethrough is opened. The contact is disposed in the fitting space as part of the fitting tubular body located in the housing space while maintaining the posture at the time of passage through the contact passing opening. According to this configuration, the card edge board (board body and contact) can be housed in the case body and the fitting tubular body while maintaining the posture parallel to the one surface of the case body having the board passing opening. Thus, it is not necessary to incline the card edge board or change the posture thereof, and the card edge board can be easily housed in the board case. Moreover, although various electronic components are mounted on both the front and back surfaces of the card edge board, the card edge board is housed in the case body while maintaining the posture parallel to the one surface of the case body having the board passing opening, and therefore, in a process of housing the card edge board, contact of the electronic components with the case body and the fitting tubular body is reduced. With the above-described configuration, a process of incorporating the card edge board into the board case can be mechanized (automated), and therefore, a cost for a process of housing the card edge board in the board case can be reduced.

(2) A board case according to the present disclosure is a board case for housing a card edge board having a contact at an end portion of a board body, the board case including: a case body forming a housing space in which the board body is housable; and a fitting tubular body forming a fitting space in which the contact of the card edge board is housable and a card edge connector connected to the card edge board is fittable, in which the fitting tubular body is formed in a tubular shape having an opening opened along a direction parallel to a principal surface of the card edge board housed in the board case and extending outward of an inside of the housing space, the case body is formed dividable into a first divided case and a second divided case, the first divided case is formed in a box shape including one surface having a board passing opening, the board passing opening is formed such that when the card edge board is housed in the board case, the board body is passable through the board passing opening in a posture of the principal surface being parallel to the one surface or a posture of the principal surface being perpendicular to the one surface, and the board body is supported by the first divided case while maintaining any one of the postures at a time of passage through the board passing opening, the second divided case is disposed with the board body interposed between the second divided case and the first divided case, and closes the board passing opening, the fitting tubular body is provided in the first divided case, and part of the fitting tubular body located in the housing space has a contact passing opening formed such that the contact is passable therethrough, and the contact is disposed in the fitting space as the part of the fitting tubular body while maintaining a posture at a time of passage through the contact passing opening.

In the disclosure of (2), the case body is dividable into the first divided case and the second divided case, and the board passing opening is opened in the one surface of the first divided case. The board passing opening is formed such that when the card edge board is housed in the board case, the board body is passable through the board passing opening in the posture of the principal surface being parallel to the one surface having the board passing opening or the posture of the principal surface being perpendicular to the one surface. The board body passes through the board passing opening in the posture parallel or perpendicular to the one surface of the first divided case having the board passing opening, enters the first divided case, and is supported (housed) by the first divided case while maintaining the posture at the time of passage through the board passing opening. In part of the fitting tubular body located in the housing space of the first divided case, the contact passing opening formed such that the contact passes therethrough is opened. The contact is disposed in the fitting space as part of the fitting tubular body located in the housing space while maintaining the posture at the time of passage through the contact passing opening. According to this configuration, the card edge board (board body and contact) can be housed in the first divided case and the fitting tubular body while maintaining the posture parallel or perpendicular to the one surface of the first divided case having the board passing opening. Thus, it is not necessary to incline the card edge board or change the posture thereof, and the card edge board can be easily housed in the board case. Moreover, although various electronic components are mounted on both the front and back surfaces of the card edge board, the card edge board is housed in the first divided case and the like while maintaining the posture parallel or perpendicular to the one surface of the first divided case having the board passing opening, and therefore, in a process of housing the card edge board, contact of the electronic components with the first divided case and the like is reduced. With the above-described configuration, a process of incorporating the card edge board into the board case can be mechanized (automated), and therefore, a cost for a process of housing the card edge board in the board case can be reduced.

(3) In the board case according to (1) or (2), it is preferred that the fitting tubular body is separated from the case body, and is attached to the case body.

According to the board case of (3), since the fitting tubular body is separated from the case body, the fitting tubular body can be attached to the case body, for example, after the card edge board has been housed in the case body. With this configuration, a process of housing the card edge board in the board case (case body) can be further facilitated.

(4) In the board case according to (3), it is preferred that the fitting tubular body is attached to the case body after the board body has been housed in the housing space, and the fitting tubular body has a partition structure dividing the housing space and the fitting space from each other, and the partition structure is configured to contact both front and back surfaces of the board body.

(5) In the board case according to (1) or (2), it is preferred that the fitting tubular body has a partition structure dividing the housing space and the fitting space from each other, and the partition structure is configured to contact the principal surface of the board body opposite to the contact passing opening and an end surface of the board body facing the opening of the fitting tubular body.

(6) In the board case according to (2), it is preferred that the board body is supported by the first divided case in a posture of the principal surface being parallel to the one surface of the first divided case, the fitting tubular body is provided with a first partition which contacts the principal surface on a first divided case side among both back and front surfaces of the board body, the second divided case is provided with a second partition which contacts the principal surface on a second divided case side among both the back and front surfaces of the board body to close the fitting space, and the first partition and the second partition form a partition structure dividing the housing space and the fitting space from each other.

According to the board case of (4) to (6), since the partition structure can divide the housing space and the fitting space from each other, entrance of a foreign substance into the housing space (inside the case body) from the fitting space can be reduced. Thus, the card edge board (electronic components mounted on the board body) can be protected from the foreign substance.

(7) A card edge board device according to the present disclosure includes: the board case according to (1) or (2); and the card edge board housed in the board case.

(8) A card edge connection structure according to the present disclosure includes: the card edge board device according to (7); and the card edge connector connected to the card edge board.

According to the card edge board device of (7) and the card edge connection structure of (8), effects similar to those of the disclosure of (1), such as an effect of easily housing the card edge board in the board case, can be obtained.

In a case where an electronic board device such as the card edge board device is manufactured, a partner housing in which the card edge connector is to be fitted may be disposed on the board body so as to surround the contact, and may be fixed to the board body by soldering or the like. In this case, the partner housing needs to be prepared and soldered, which takes extra time and effort for manufacturing the electronic board device and increases a manufacturing cost. On the other hand, in the card edge board device according to (7) and the card edge connection structure according to (8), the fitting tubular body provided in the case body functions as a quasi-partner housing which houses the contact. According to this configuration, a process of fixing the partner housing to the board body can be omitted, and therefore, the card edge board device can be easily manufactured at a low cost.

(9) In the card edge connection structure according to (8), it is preferred that the contact of the card edge board includes contacts provided on both front and back surfaces of the end portion of the board body, the card edge connector has a housing including a pair of contact housings and a board entrance groove, and a plurality of terminals, the board entrance groove is configured such that when the card edge connector is fitted in the fitting tubular body, the end portion of the board body enters the board entrance groove, and the pair of contact housings faces each other with the board entrance groove therebetween, the plurality of terminals is housed in the housing, sandwiches the end portion having entered the board entrance groove, and contacts the contacts provided on both the front and back surfaces of the end portion of the board body, the housing has a rib bridged between the pair of contact housings, and the end portion of the board body is formed with a cutout in which the rib is fitted when the card edge connector is fitted in the fitting tubular body.

According to the card edge connection structure of (9), the rib couples the pair of contact housings. Thus, separation or approaching of the pair of contact housings can be reduced, and the pair of contact housings can be maintained with a predetermined interval. With this configuration, the interval between the plurality of terminals housed in the pair of contact housings is also constant, and therefore, the terminals can contact the contacts on both the front and back surfaces of the card edge board with proper pressure. When the card edge connector is fitted in the fitting tubular body, the rib is fitted in the cutout, and therefore, vibration of the card edge connector along the direction parallel to the principal surface of the card edge board can also be reduced. Since the pair of contact housings is coupled by the rib, the stiffness of the entirety of the housing is improved, and therefore, vibration of the card edge connector along the direction perpendicular to the principal surface of the card edge board in a state of the end portion (contacts) of the card edge board being sandwiched by the board entrance groove can also be reduced.

According to the present disclosure, the card edge board can be easily housed in the board case.

Hereinafter, embodiments of the present disclosure will be described with reference to the attached drawings. Note that X1, X2, Y1, Y2, Z1, and Z2 shown in each figure indicate the left, the right, the front, the rear, the up, and the down, respectively. Moreover, in the following description, the “front” is the Y1 side, and the “rear” is the Y2 side. Further, the “front-rear direction”, the “up-down direction”, and the “left-right direction” are perpendicular to each other. In the following description, the left-right direction may be referred to as an X1X2 direction, the front-rear direction may be referred to as a Y1Y2 direction, and the up-down direction may be referred to as a Z1Z2 direction. Terms used to indicate directions and positions in the following description are used for the sake of convenience in description, and do not limit the technical scope of the present disclosure.

### First Embodiment

### Card Edge Connection Structure

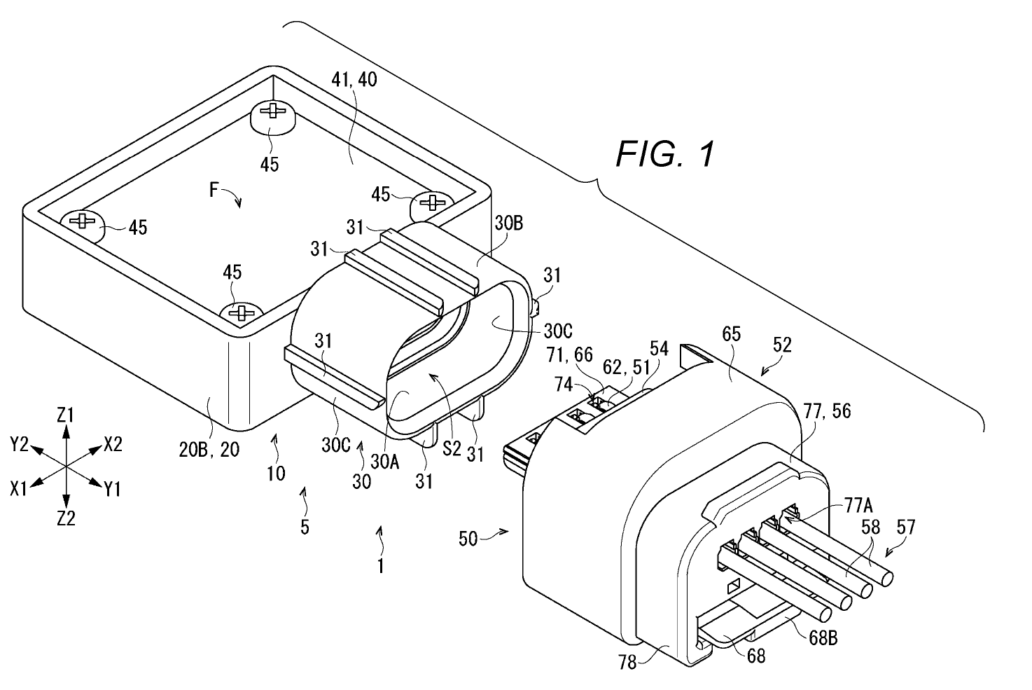

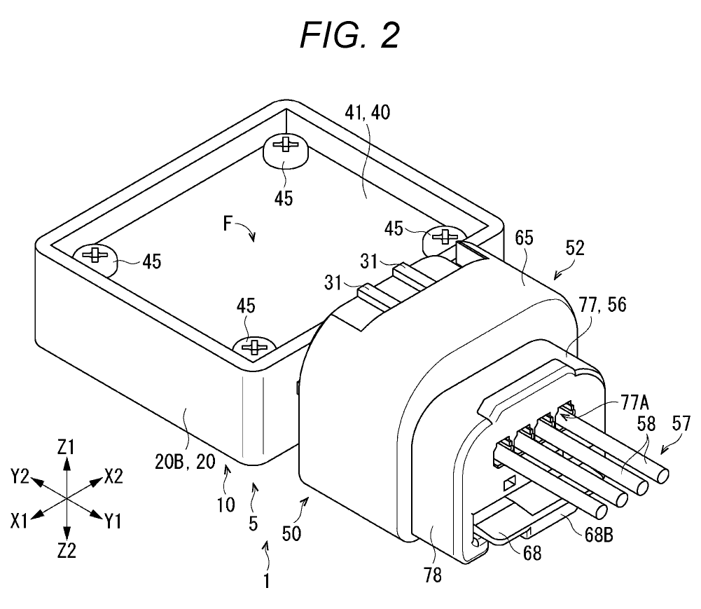

With reference to FIGS. 1 and 2, a card edge connection structure 1 according to a first embodiment will be described. FIGS. 1 and 2 are perspective views showing the card edge connection structure 1.

The card edge connection structure 1 includes a card edge board device 5 and a card edge connector 50. The card edge board device 5 is, for example, an electronic control unit (ECU) mounted on an automobile. The card edge board device 5 includes a board case 10 forming an exterior, and a card edge board 40 housed in the board case 10. The card edge connector 50 is attached to a tip end portion of a wire harness 57 extending from a control target (not shown). The card edge connector 50 is fitted in a fitting tubular body 30 of the board case 10, and is connected to the card edge board 40 housed in the board case 10.

### Board Case

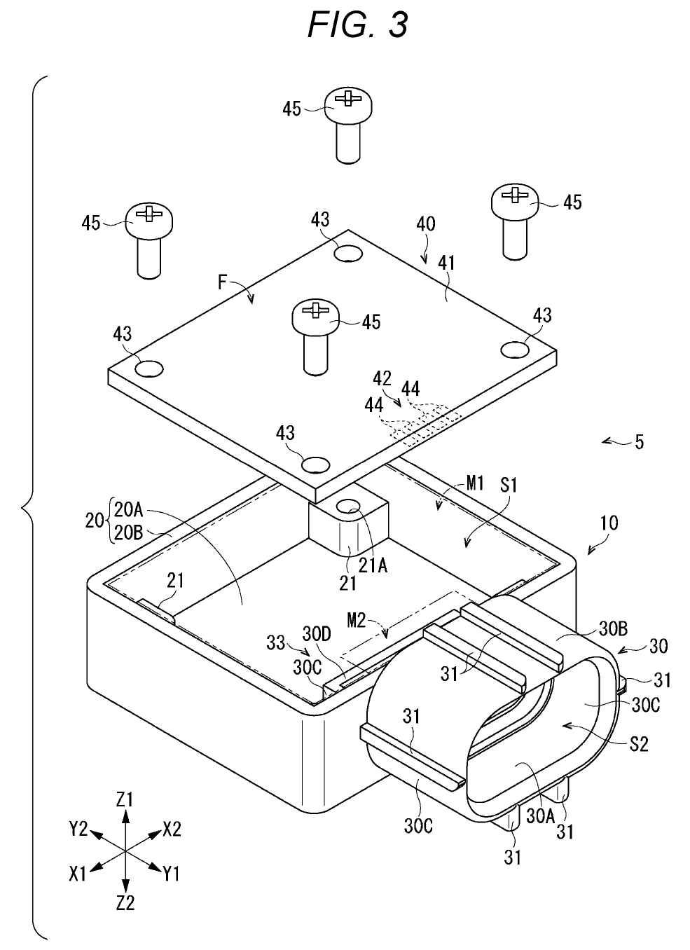

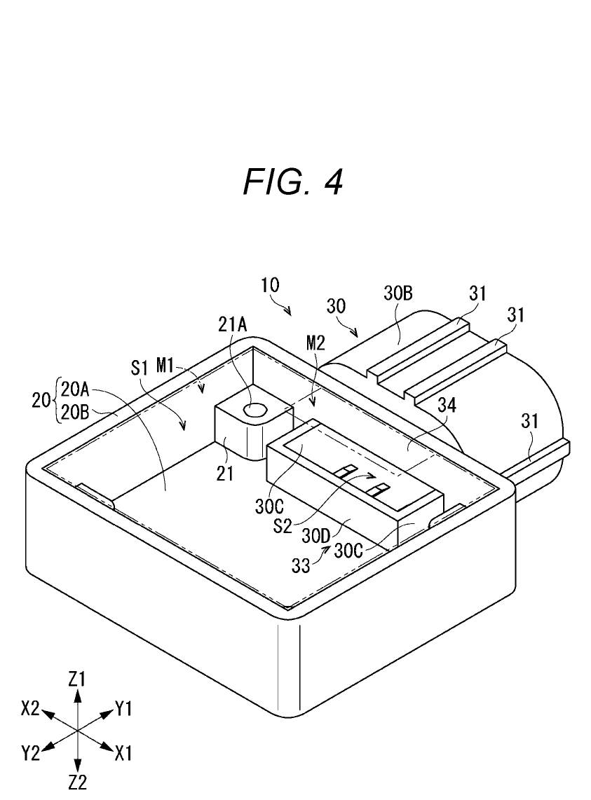

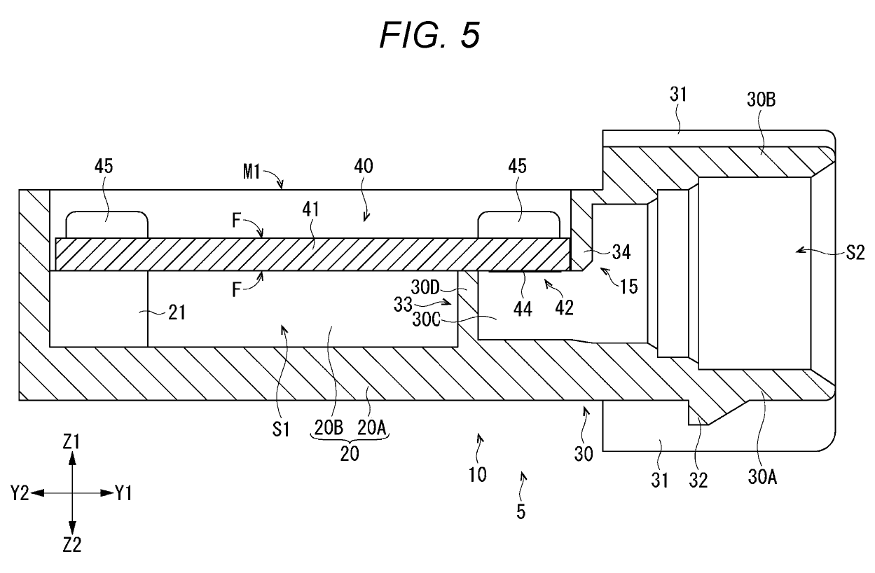

With reference to FIGS. 1-5, the board case 10 will be described. FIG. 3 is an exploded perspective view showing the card edge board device 5. FIG. 4 is a perspective view showing the board case 10. FIG. 5 is a sectional view showing the card edge board device 5.

As shown in FIGS. 1 and 2, the board case 10 is a container housing the card edge board 40. The board case 10 is made of, for example, metal or synthetic resin. The board case 10 includes a case body 20 and the fitting tubular body 30. The case body 20 is formed in a rectangular parallelepiped shape with a small height, and has therein a housing space S1 (see FIG. 3) in which the card edge board 40 (board body 41) can be housed. The fitting tubular body 30 is formed in a rectangular tubular shape narrower in the left-right direction than the case body 20 and protruding forward of the case body 20. The fitting tubular body 30 forms a fitting space S2 (see FIG. 1) in which the card edge connector 50 is fittable.

### Case Body

The case body 20 is formed in a box shape including one surface with a board passing opening M1. In the present embodiment, the board passing opening M1 is provided in the upper surface of the case body 20 (see FIGS. 3-5).

Specifically, the case body 20 is formed in such a deep tray shape that a rectangular peripheral wall 20B stands on a peripheral edge portion of a bottom wall 20A. The bottom wall 20A is formed in a quadrangular flat plate shape. The rectangular peripheral wall 20B is formed in a rectangular tubular shape, and extends upward of the peripheral edge portion of the bottom wall 20A. As indicated by a dash-dot-dot line (virtual line) in FIGS. 3 and 4, the board passing opening M1 is a quadrangular opening defined by the upper edge of the rectangular peripheral wall 20B, and in plan view, the entirety of the bottom wall 20A is exposed therethrough. Note that the upper surface of the case body 20 may be taken as the upper surface of the case body 20 in a case where it is assumed that there is no board passing opening M1.

Board fixing portions 21 are provided at four corner portions of the case body 20, respectively. The four board fixing portions 21 protrude upward of the bottom wall 20A (FIG. 3 and the like show only some of the four board fixing portions 21). Each board fixing portion 21 is formed in a rectangular parallelepiped shape, and the upper surface thereof is formed with an internal threaded hole 21A. The upper surface of each board fixing portion 21 is located in the vicinity of the center of the rectangular peripheral wall 20B in the up-down direction (Z1Z2 direction) (see FIG. 5).

### Fitting Tubular Body

As shown in FIGS. 3-5, the fitting tubular body 30 is molded integrally with the case body 20 at a center portion of the front of the rectangular peripheral wall 20B in the left-right direction. A rear portion of the fitting tubular body 30 bites into the case body 20, and the fitting tubular body 30 extends outward (forward) of the inside of the case body 20 (housing space S1). The fitting tubular body 30 is formed in a tubular shape narrower in the left-right direction than the case body 20. Specifically, the fitting tubular body 30 is formed in a tubular shape having a rectangular section long in the left-right direction with rounded corners, and is opened forward (along a direction parallel to a principal surface F of the card edge board 40). That is, the fitting tubular body 30 has, in front thereof, an opening communicating with the fitting space S2.

The fitting tubular body 30 is formed in the rectangular tubular shape by a tube bottom wall 30A, a tube top wall 30B, and a pair of tube side walls 30C. The tube bottom wall 30A and the tube top wall 30B face each other in the up-down direction with the fitting space S2 interposed therebetween. The pair of tube side walls 30C is bridged between both the left and right ends of the tube bottom wall 30A and both the left and right ends of the tube top wall 30B.

The outer peripheral surface of the fitting tubular body 30 located outside the case body 20 is formed with a plurality of fitting protrusions 31 protruding outward in a radial direction. In the present embodiment, each of the outer surface of the tube bottom wall 30A and the outer surface of the tube top wall 30B is formed with a pair of fitting protrusions 31, and each of the pair of tube side walls 30C is formed with one fitting protrusion 31. An engagement claw 32 protrudes from the outer surface (lower surface) of the tube bottom wall 30A (see FIG. 5). The engagement claw 32 is provided between the pair of fitting protrusions 31 on the lower surface side of the tube bottom wall 30A, and is formed in a block shape having a surface inclined downward while extending rearward from the front.

In the case body 20 (housing space S1), the tube top wall 30B is omitted. A rear portion (inside the case body 20) of each tube side wall 30C is formed shorter (lower) in the up-down direction than a front portion (outside the case body 20). The upper end surface of the rear portion of each tube side wall 30C is coincident with the upper surface of the board fixing portion 21. The fitting tubular body 30 further has a tube end wall 30D coupled to the rear end of the tube bottom wall 30A and the rear ends of the pair of tube side walls 30C. The tube end wall 30D protrudes upward of the rear end of the tube bottom wall 30A and the rear end of the bottom wall 20A. The upper end surface of the tube end wall 30D is coincident with the upper end surface of the board fixing portion 21. The tube end wall 30D and the rear portions of the pair of tube side walls 30C form a first partition 33 formed in a U-shape opened forward in plan view and configured to contact the lower surface (principal surface F) of the card edge board 40. The first partition 33 is a partition wall dividing the case body 20 and the fitting tubular body 30 from each other.

As shown in FIGS. 4 and 5, the fitting tubular body 30 has a second partition 34 suspending from a rear end portion of the tube top wall 30B. The second partition 34 is part (center portion in the left-right direction) of a front wall portion of the rectangular peripheral wall 20B of the case body 20. The second partition 34 is coupled to a center portion in the left-right direction of the tube top wall 30B and a center portion in the left-right direction of the pair of tube side walls 30C. The lower end of the second partition 34 is located at the same height as that of the upper end of the tube end wall 30D (first partition 33), and is apart upward from the tube bottom wall 30A. A lower corner portion of the front of the second partition 34 is diagonally chamfered.

Part (rear portion) of the fitting tubular body 30 located inside the case body 20 (housing space S1) is formed with a contact passing opening M2. As indicated by a dash-dot-dot line (virtual line) in FIGS. 3 and 4, the contact passing opening M2 is a quadrangular opening defined by the upper edges of the rear portions of the pair of tube side walls 30C and the upper edge of the tube end wall 30D, and in plan view, a rear portion of the tube bottom wall 30A is exposed therethrough. Specifically, the first partition 33 (rear portion of each tube side wall 30C and tube end wall 30D) is provided lower than a front portion of the fitting tubular body 30 (each tube side wall 30C). Thus, assuming that the first partition 33 is at the same height as that of the front portion of the fitting tubular body 30, the contact passing opening M2 is an opening defined by the upper edges of the rear portions of the pair of tube side walls 30C and the upper edge of the tube end wall 30D. Note that in the present embodiment, the contact passing opening M2 is included in the board passing opening M1 and also serves as the board passing opening M1, and therefore, may be taken as part of the board passing opening M1.

### Card Edge Board

With reference to FIGS. 3 and 5, the card edge board 40 will be described. The card edge board 40 is a so-called electrical board (printed circuit board), and has a board body 41 formed in a thin plate shape and a contact 42 formed on the lower surface of an end portion of the board body 41.

### Board Body

In plan view, the board body 41 is formed in a quadrangular shape slightly smaller than the board passing opening M1 of the case body 20. In other words, the board body 41 (card edge board 40) is formed so as to be passable through the board passing opening M1 in a horizontal posture (posture parallel to the upper surface or bottom wall 20A of the case body 20) and be housable in the case body 20 in the horizontal posture. Four corner portions of the board body 41 are formed with loose insertion holes 43 through which screws 45 are insertable in a thickness direction (up-down direction). Note that although not shown in the figure, at least one of the upper surface (front surface) or lower surface (back surface) of the board body 41 is formed with an electrical circuit, and a plurality of electronic components is mounted (soldered) thereon.

Note that in the present specification, a main surface of surfaces of the board body 41 (card edge board 40) formed in the thin plate shape, which has a substantially greater area than those of other surfaces, is referred to as a “principal surface F”. Since the board body 41 (card edge board 40) is in the thin plate shape, there is naturally another surface facing one principal surface F and having a great area. That is, two principal surfaces F are on both the front and back sides of the board body 41 (card edge board 40), and one of the two principal surfaces F is a front surface, and the other principal surface F is a back surface.

### Contact

The contact 42 is formed at a center portion in the left-right direction at a front edge portion of the board body 41. The contact 42 is part of the board body 41 including a plurality of electrode patterns 44 formed on the lower surface (back surface) of the board body 41. For example, four electrode patterns 44 are formed at equal intervals in the left-right direction on the lower surface of the board body 41. Each electrode pattern 44 is electrically connected to the electrical circuit formed on the board body 41.

### Steps of Assembling Card Edge Board Device according to First Embodiment

With reference to FIGS. 1, 3, and 5, one example of steps of assembling the card edge board device 5 according to the first embodiment, in other words, steps of housing the card edge board 40 in the board case 10 will be described. The card edge board device 5 is automatically assembled using a manufacturing apparatus (not shown), or is manually assembled by a worker, for example.

The board case 10 is placed on a horizontal top plate of a work table in a posture (horizontal posture) of the board passing opening M1 and the contact passing opening M2 facing up. The card edge board 40 is disposed above the board case 10 in the horizontal posture (posture of the principal surface F being parallel to the upper surface of the board case 10) (see FIG. 3). The card edge board 40 moves downward while maintaining the horizontal posture, the board body 41 enters the case body 20 (housing space S1) through the board passing opening M1, and the contact 42 enters the fitting tubular body 30 (fitting space S2) through the contact passing opening M2. The board body 41 is placed on the upper end surfaces of the four board fixing portions 21 and the upper end surface of the first partition 33, and is fixed to the case body 20 by screwing each screw 45 penetrating the loose insertion hole 43 into the internal threaded hole 21A of the board fixing portion 21 (see FIGS. 1 and 5).

As described above, the case body 20 supports the board body 41 having passed through the board passing opening M1 in the horizontal posture (posture of the principal surface F being parallel to the upper surface which is the one surface having the board passing opening M1) while maintaining the posture at the time of passage. In this state, as shown in FIG. 5, in the housing space S1 of the case body 20, the board body 41 having passed through the board passing opening M1 is housed while maintaining the posture at the time of passage through the board passing opening M1, and in the fitting space S2 as part of the fitting tubular body 30 located in the housing space S1, the contact 42 having passed through the contact passing opening M2 is disposed while maintaining the posture at the time of passage through the contact passing opening M2.

The upper end surface of the first partition 33 of the fitting tubular body 30 contacts the lower surface (principal surface F of the board body 41 on the side opposite to the contact passing opening M2) of the board body 41. The rear surface of a lower portion of the second partition 34 contacts the front end surface (end surface facing the front opening of the fitting tubular body 30) of the board body 41 (contact 42). The first partition 33 and the second partition 34 form a partition structure 15 dividing the housing space S1 and the fitting space S2 from each other.

Next, a potting material (not shown) such as urethane resin is injected (filled) into the case body 20 (housing space S1) to seal the board body 41. In this manner, the waterproof properties, dust resistance, quake resistance, and the like of the board body 41 are improved. Note that in a case where the waterproof properties and the like are not necessary, the potting material may be omitted.

As described above, the card edge board device 5 is completed.

In the card edge board device 5 (board case 10) according to the first embodiment as described above, the board passing opening M1 is opened in the upper surface of the case body 20, and the board body 41 passes through the board passing opening M1 in the posture (horizontal posture) parallel to the upper surface (or the bottom surface) of the case body 20. Moreover, the contact passing opening M2 through which the contact 42 passes is opened in part of the fitting tubular body 30 located in the housing space S1, and the contact 42 having passed through the contact passing opening M2 is disposed in the fitting space S2. According to this configuration, the card edge board 40 (board body 41 and contact 42) can be housed in the case body 20 and the fitting tubular body 30 while maintaining the posture parallel to the upper surface of the case body 20. With this configuration, it is not necessary to incline the card edge board 40 or change the posture thereof, and the card edge board 40 can be easily housed in the board case 10. Moreover, although various electronic components are mounted on both the front and back surfaces of the card edge board 40, the card edge board 40 is housed in the case body 20 while maintaining the horizontal posture, and therefore, in a process of housing the card edge board 40, contact of the electronic components with the case body 20 and the fitting tubular body 30 is reduced. With the above-described configuration, a process of incorporating the card edge board 40 into the board case 10 can be mechanized (automated), and therefore, a cost for a process of housing the card edge board 40 in the board case 10 can be reduced.

In the card edge board device 5 (board case 10) according to the first embodiment, the partition structure 15 divides the housing space S1 and the fitting space S2 from each other. According to this configuration, before the case body 20 is filled with the potting material, entrance of a foreign substance into the housing space S1 (inside the case body 20) from the fitting space S2 can be reduced. Thus, the card edge board 40 (electronic components mounted on the board body 41) can be protected from the foreign substance. Moreover, leakage of the potting material from the case body 20 to the fitting space S2 can also be reduced.

Note that in the board case 10 according to the first embodiment, the upper surface of the case body 20 is opened, but the present disclosure is not limited thereto. For example, the board case 10 may include a lid (not shown) that closes the upper surface (board passing opening M1) of the case body 20 after the card edge board 40 has been housed in the case body 20. In this case, the potting material may be omitted.

### Card Edge Connector

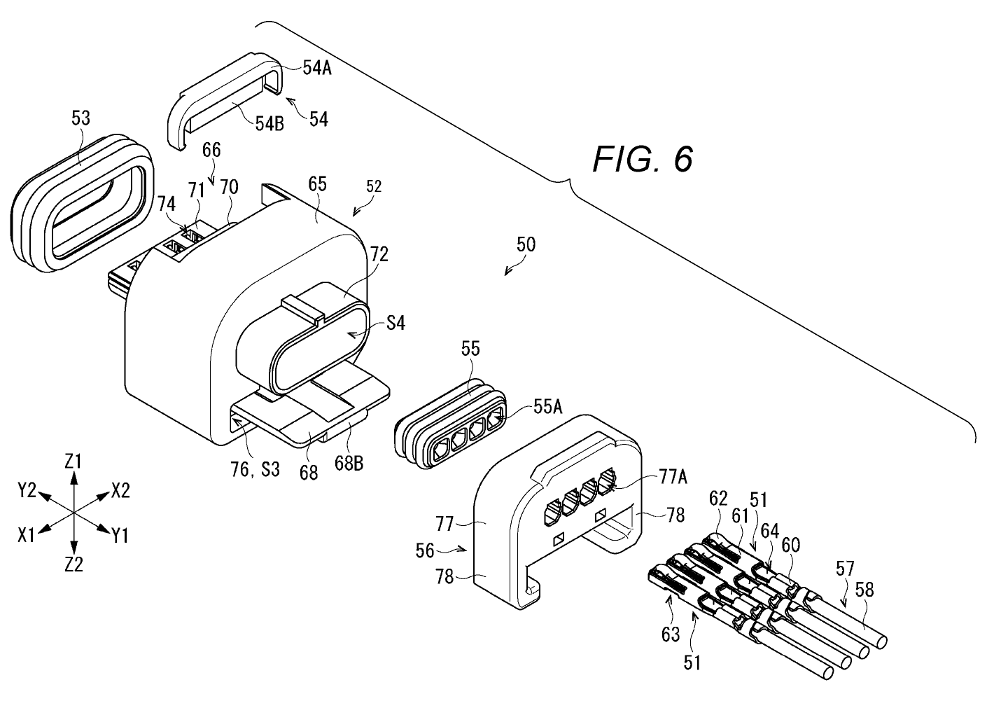

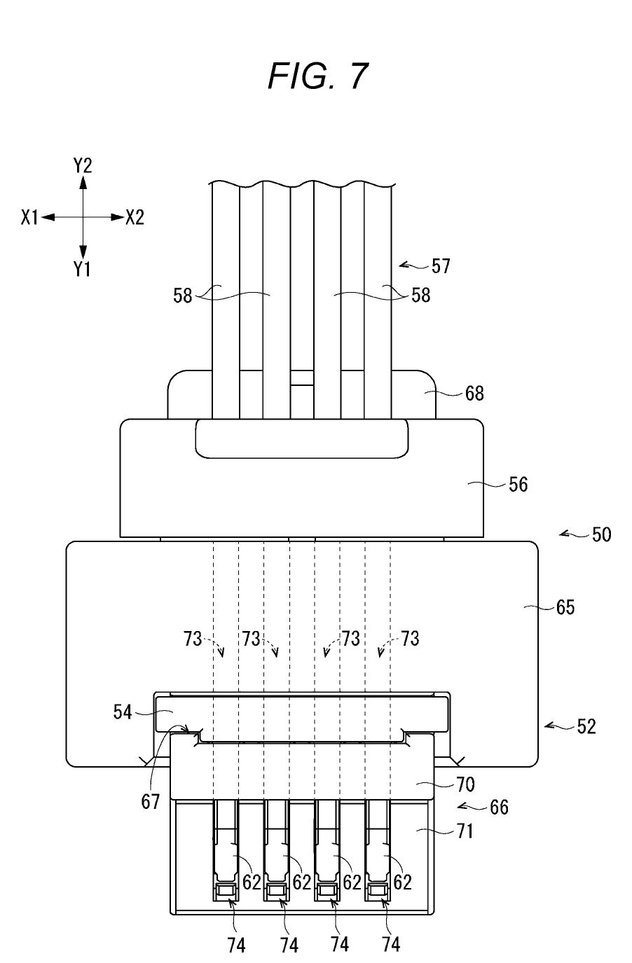

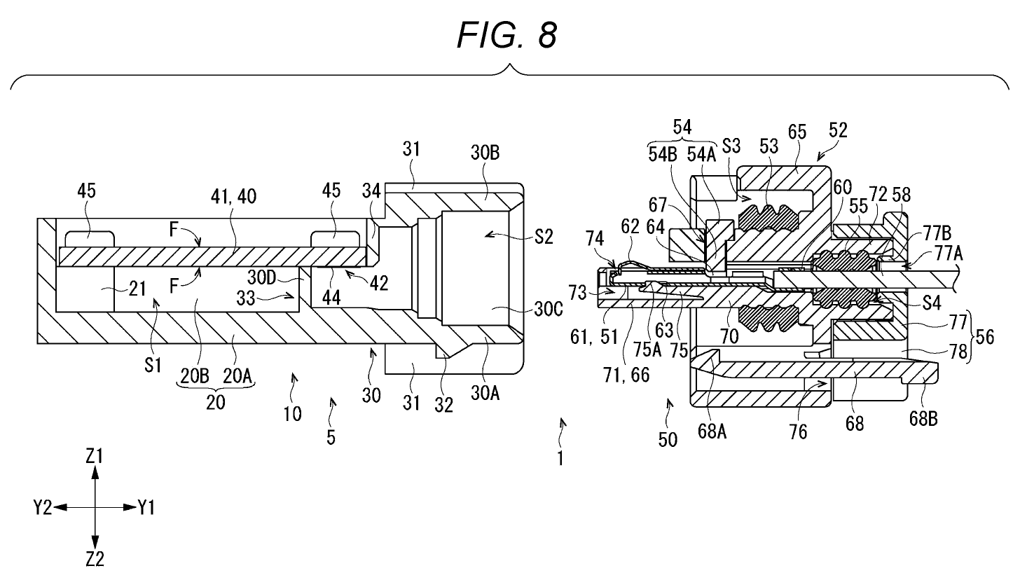

Next, the card edge connector 50 will be described with reference to FIGS. 6-8. FIG. 6 is an exploded perspective view showing the card edge connector 50. FIG. 7 is a plan view showing the card edge connector 50. FIG. 8 is a sectional view showing the card edge connection structure 1 (before connection).

The card edge connector 50 is a so-called waterproof connector, and has a structure of sealing a gap with the fitting tubular body 30 when fitted in the fitting tubular body 30 of the board case 10. As shown in FIG. 6, the card edge connector 50 includes a plurality of terminals 51 (for example, four terminals 51), a housing 52, a housing seal 53, a retainer 54, a wire seal 55, and a seal cover 56. Note that the plurality of terminals 51 has the same structure, and for this reason, one terminal 51 will be mainly described in the present specification. Moreover, the same also applies to a plurality of components provided corresponding to the plurality of terminals 51. Note that as the terminals 51, the components provided corresponding to the terminals 51, and the like, at least one terminal 51, at least one component, and the like may be provided, and the numbers of terminals 51 and components may be freely increased or decreased.

### Terminal

The four terminals 51 are arranged in line in the left-right direction. The terminal 51 is fixed to a tip end portion (rear end portion) of a cable 58 (electrical wire). The terminal 51 is formed, for example, in such a manner that a single metal plate is punched and bent. The terminal 51 has a crimping portion 60 crimped to the tip end portion of the cable 58, and a connection portion 61 extending rearward of the crimping portion 60. The connection portion 61 is formed in a tubular shape, a terminal contact 62 bent so as to protrude upward is formed on the upper surface of the connection portion 61, and a lock hole 63 is opened in the lower surface of the connection portion 61. Moreover, a holding gap 64 is formed between the upper surface of the connection portion 61 and the crimping portion 60. Note that the plurality of cables 58 fixed to the plurality of terminals 51 is bundled to form the wire harness 57.

### Housing

As shown in FIGS. 6-8, the housing 52 has an outer tube portion 65, an inner tube portion 66, a holding attachment hole 67, and a lock arm 68. The housing 52 is integrally molded of non-conductive synthetic resin, for example.

### Outer Tube Portion and Inner Tube Portion

The outer tube portion 65 is formed in a tubular shape having a rectangular section long in the left-right direction with rounded corners, and is opened rearward. The fitting tubular body 30 of the board case 10 is fitted in the outer tube portion 65 (see FIG. 2). The inner tube portion 66 is disposed inside the outer tube portion 65. The inner tube portion 66 is formed longer in the front-rear direction than the outer tube portion 65, and extends outward of both the end surfaces of the outer tube portion 65 in the front-rear direction. The inner tube portion 66 has a housing body 70, a contact housing 71, and a seal housing 72.

### Housing Body

The housing body 70 is formed in a tubular shape formed smaller than the outer tube portion 65 and having a rectangular section long in the left-right direction with rounded corners. The housing body 70 is coupled to a front end portion of the outer tube portion 65, extends rearward of the front end of the outer tube portion 65, and protrudes rearward of the opening of the outer tube portion 65. The housing body 70 is formed so as to enter the fitting tubular body 30 of the board case 10 (fitting space S2). An annular seal disposing space S3 is formed between the outer tube portion 65 and the housing body 70 (see FIG. 8). In the seal disposing space S3, the housing seal 53 described later is disposed. Note that a rear upper portion of the outer tube portion 65 is cut out such that a rear portion (holding attachment hole 67) of the housing body 70 is opened.

### Contact Housing

The contact housing 71 is formed in a thick plate shape extending rearward of a lower portion of the rear end surface of the housing body 70. The contact housing 71 is thinner than the housing body 70, and is formed so as to enter between the tube bottom wall 30A of the fitting tubular body 30 and the card edge board 40 (contact 42) (see FIG. 8).

### Housing Chamber

Four housing chambers 73 housing the four terminals 51 in an electrically-insulated state are provided in line in the left-right direction in the housing body 70 and the contact housing 71 (see FIG. 7). The housing chamber 73 is a through-hole penetrating the housing body 70 and the contact housing 71 in the front-rear direction. The terminal 51 is inserted into the housing chamber 73 through an opening formed in the front end surface of the housing body 70. Four contact holes 74 each communicating with the four housing chambers 73 are opened in the top surface of the contact housing 71. The terminal contact 62 of the terminal 51 housed in the housing chamber 73 is exposed through the contact hole 74.

As shown in FIG. 8, a lance 75 protruding upward of the bottom surface and extending rearward is provided in the housing chamber 73. The lance 75 is formed displaceable in the up-down direction with elastic force with a base portion (front end portion) as the point of support. A tip end portion (rear end portion) of the lance 75 is formed with a lance claw 75A which engages with the lock hole 63 of the terminal 51 housed in the housing chamber 73.

### Seal Housing

As shown in FIG. 6, the seal housing 72 is formed in a tubular shape having a rectangular section long in the left-right direction with rounded corners. The seal housing 72 is coupled to the front end portion of the outer tube portion 65, and protrudes forward of the front end of the outer tube portion 65. In the seal housing 72, a seal press-fitting space S4 communicating with the four housing chambers 73 is formed. The wire seal 55 described later is inserted into the seal press-fitting space S4 with pressure (see FIG. 8).

### Holding Attachment Hole

The holding attachment hole 67 is opened in the upper surface of the housing body 70 in the cutout portion of the rear upper portion of the outer tube portion 65 (see FIG. 8). The holding attachment hole 67 is a through-hole formed long in the left-right direction so as to extend across the four housing chambers 73 and communicating with the four housing chambers 73. The retainer 54 described later is attached to the holding attachment hole 67.

### Lock Arm

As shown in FIGS. 6 and 8, the lock arm 68 is formed in a flat plate shape extending in the front-rear direction, and is provided in a lower portion of the seal disposing space S3. An arm insertion hole 76 communicating with the seal disposing space S3 is opened in a lower portion of the front of the outer tube portion 65, and the lock arm 68 is swingably supported with the upper edge of the arm insertion hole 76 as the point of support. The lock arm 68 extends to both sides in the front-rear direction from the arm insertion hole 76, the rear end of the lock arm 68 is coincident with the rear end of the housing body 70, and the front end of the lock arm 68 is located forward of the front end of the inner tube portion 66 (seal housing 72). A lock claw 68A protrudes from a rear end portion of the upper surface of the lock arm 68. A disengagement portion 68B is provided at a front end portion of the lower surface of the lock arm 68.

### Housing Seal

The housing seal 53 is formed in an annular shape from an elastically-deformable material such as synthetic rubber. Recesses and projections are formed in a corrugated shape in the inner peripheral surface and outer peripheral surface of the housing seal 53 (see FIGS. 6 and 8). As shown in FIG. 8, the inner tube portion 66 of the housing 52 penetrates the annular housing seal 53, and the housing seal 53 is disposed in the seal disposing space S3. The housing seal 53 disposed in the seal disposing space S3 closely contacts the outer peripheral surface of the housing body 70 of the inner tube portion 66 while crushing the projections on the inner peripheral surface.

### Retainer

The retainer 54 is integrally molded of non-conductive synthetic resin, for example. As shown in FIG. 6, the retainer 54 has a holding exterior portion 54A formed in a standing U-shape, and a holding projection 54B protruding downward of the lower surface of the holding exterior portion 54A. The holding projection 54B is inserted into the holding attachment hole 67 of the housing body 70, and is formed so as to enter the four housing chambers 73.

### Wire Seal

The wire seal 55 is formed in a rectangular parallelepiped shape from an elastically-deformable material such as synthetic rubber, for example. As shown in FIGS. 6 and 8, the wire seal 55 is formed in a rectangular shape long in the left-right direction with rounded corners in front view, and is formed fittable in the seal press-fitting space S4 of the seal housing 72. Recesses and projections are formed in a corrugated shape in the outer peripheral surface of the wire seal 55. The wire seal 55 is formed with four seal through-holes 55A through which the four cables 58 penetrate and which are formed in line in the left-right direction. The four seal through-holes 55A communicate with the four housing chambers 73 of the housing 52 in a state of the wire seal 55 being fitted in the seal press-fitting space S4. Recesses and projections are formed in a corrugated shape in the inner peripheral surface of each seal through-hole 55A.

### Seal Cover

As shown in FIGS. 6-8, the seal cover 56 has a cover body 77 formed slightly larger than the seal housing 72 of the housing 52, and a pair of cover arms 78 extending downward of both sides of the cover body 77 in the left-right direction. The seal cover 56 is integrally molded of non-conductive synthetic resin, for example. The cover body 77 is formed in a box shape opened in the rear surface. A front wall of the cover body 77 is formed with four cover through-holes 77A through which the four cables 58 penetrate and which are formed in line in the left-right direction. The front wall of the cover body 77 is formed with four cover projections 77B which protrude inward (rearward) of peripheral edge portions of the four cover through-holes 77A. The pair of cover arms 78 extends downward of both sides of the cover body 77 in the left-right direction, and is then bent in a direction of the cover arms 78 approaching each other.

### Steps of Assembling Card Edge Connector according to First Embodiment

Next, one example of steps of assembling the card edge connector 50 according to the first embodiment will be described with reference to FIGS. 1 and 6-8.

The terminal 51 is crimped to the tip end portion of the cable 58, and rearward from the front, penetrates the cover through-hole 77A of the seal cover 56 and penetrates the seal through-hole 55A of the wire seal 55 (see FIG. 8). The cable 58 is disposed inside the seal through-hole 55A, and closely contacts the inner peripheral surface of the seal through-hole 55A while crushing the projections on the inner peripheral surface of the seal through-hole 55A (see FIG. 8). The terminal 51 passes through the seal housing 72 of the housing 52, and is inserted into the housing chamber 73 through the opening formed in the front end surface of the housing body 70. The terminal 51 is inserted while a tip end portion of the connection portion 61 is contacting the lance claw 75A and the lance 75 is being elastically deformed. Along with insertion of the terminal 51, the lance claw 75A relatively moves forward while contacting the connection portion 61, and is fitted in the lock hole 63 of the connection portion 61 (see FIG. 8). In this state, the terminal contact 62 of the terminal 51 protrudes from the contact hole 74 of the contact housing 71, and the holding gap 64 of the connection portion 61 faces the holding attachment hole 67 (see FIG. 8).

The retainer 54 is inserted downward into the holding attachment hole 67 from above, and is housed inside the holding attachment hole 67. When the retainer 54 is housed in the holding attachment hole 67, the holding projection 54B of the retainer 54 protrudes into the four housing chambers 73, and is fitted in the holding gaps 64 of the terminals 51 housed in the housing chambers 73 (see FIG. 8). Since the holding projection 54B contacts the rear end of the connection portion 61, removal of the terminal 51 housed in the housing chamber 73 is restricted. Note that the holding exterior portion 54A forms part of the exterior of the housing body 70.

The wire seal 55 is pushed rearward into the seal press-fitting space S4 of the seal housing 72 from the front with pressure, and is fitted in the seal press-fitting space S4 (see FIG. 8). The wire seal 55 fitted in the seal press-fitting space S4 closely contacts the inner peripheral surface of the seal housing 72 while crushing the projections on the outer peripheral surface (see FIG. 8). Accordingly, a gap between the housing 52 and the cable 58 is closed, and the housing 52 is waterproofed. The seal cover 56 covers the seal housing 72 of the housing 52 from the front, and presses the wire seal 55 fitted in the seal housing 72 (see FIGS. 7 and 8). The cover projections 77B of the seal cover 56 closely contact the front end of the wire seal 55 (see FIG. 8). The pair of cover arms 78 of the seal cover 56 is disposed so as to rim the front side of the arm insertion hole 76 of the outer tube portion 65 (see FIG. 1). The lock arm 68 exposed through the arm insertion hole 76 is disposed between the pair of cover arms 78.

As described above, the card edge connector 50 is completely assembled.

### Connection between Card Edge Board Device and Card Edge Connector according to First Embodiment

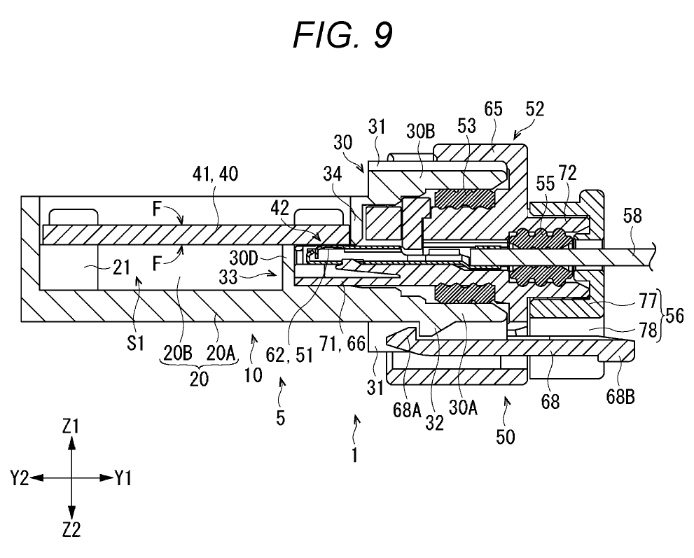

Next, with reference to FIGS. 1, 2, 8, and 9, one example of steps of connecting the card edge connector 50 to the card edge board device 5 will be described. FIG. 9 is a sectional view showing the card edge connection structure 1 (after connection).

The inner tube portion 66 of the card edge connector 50 is inserted into the fitting tubular body 30 (fitting space S2) of the board case 10 from the front opening thereof, and the fitting tubular body 30 is inserted between the outer tube portion 65 and the inner tube portion 66 (seal disposing space S3). When the card edge connector 50 is inserted into the fitting tubular body 30, the plurality of fitting protrusions 31 of the fitting tubular body 30 contacts the inner peripheral surface of the outer tube portion 65. The card edge connector 50 is inserted into the fitting tubular body 30 while being guided by the plurality of fitting protrusions 31.

In a process of inserting the card edge connector 50 into the fitting tubular body 30, the lock claw 68A contacts the engagement claw 32 of the fitting tubular body 30, and the lock arm 68 is elastically deformed downward. The lock claw 68A passes over the engagement claw 32, and engages with the engagement claw 32 (see FIG. 9). In this manner, detachment of the card edge connector 50 fitted in the fitting tubular body 30 is restricted.

In the process of inserting the card edge connector 50 into the fitting tubular body 30, the contact housing 71 of the housing 52 enters below a front end portion of the board body 41, and the terminal contact 62 protruding from the contact housing 71 contacts a lower end portion of the second partition 34. When the card edge connector 50 is further inserted, the terminal contact 62 is pushed downward while contacting the second partition 34 and the contact 42, and contacts the electrode pattern 44 of the contact 42 with elastic force (see FIG. 9).

Further, in the process of inserting the card edge connector 50 into the fitting tubular body 30, the fitting tubular body 30 relatively enters the seal disposing space S3, and is pushed in between the inner peripheral surface of the outer tube portion 65 and the outer peripheral surface of the housing seal 53 with pressure. The housing seal 53 closely contacts the inner peripheral surface of the fitting tubular body 30 while crushing the projections on the outer peripheral surface (see FIG. 9). In this manner, a gap between the housing 52 and the fitting tubular body 30 is closed.

As described above, the card edge connector 50 is fitted in the fitting tubular body 30, and is connected to the card edge board device 5 (card edge board 40) (see FIGS. 2 and 9). In this state, the contact housing 71 is disposed below the contact 42, and the tip end surface (rear end surface) of the contact housing 71 abuts on the front of the tube end wall 30D of the first partition 33 (or faces the front with a slight gap therebetween). The tip end surface (rear end surface) of the housing body 70 abuts on the front of the second partition 34 (or faces the front with a slight gap therebetween). Note that in a case where the card edge connector 50 is pulled out of the fitting tubular body 30, the disengagement portion 68B may be pushed up, the lock arm 68 may be turned, and the card edge connector 50 may be pulled out while the lock claw 68A is separated from the engagement claw 32.

In a case where an electronic board device such as the card edge board device 5 is manufactured, a partner housing in which the card edge connector 50 is to be fitted may be disposed on the board body 41 so as to surround the contact 42, and may be fixed to the board body 41 by soldering or the like (not shown). In this case, the partner housing needs to be prepared and soldered, which takes extra time and effort for manufacturing the electronic board device and increases a manufacturing cost. On the other hand, in the card edge connection structure 1 (card edge board device 5) according to the first embodiment, the fitting tubular body 30 functions as a quasi-partner housing which houses the contact 42. According to this configuration, a process of fixing the partner housing to the board body 41 can be omitted, and therefore, the card edge board device 5 can be easily manufactured at a low cost.

### Other Embodiments and Modifications

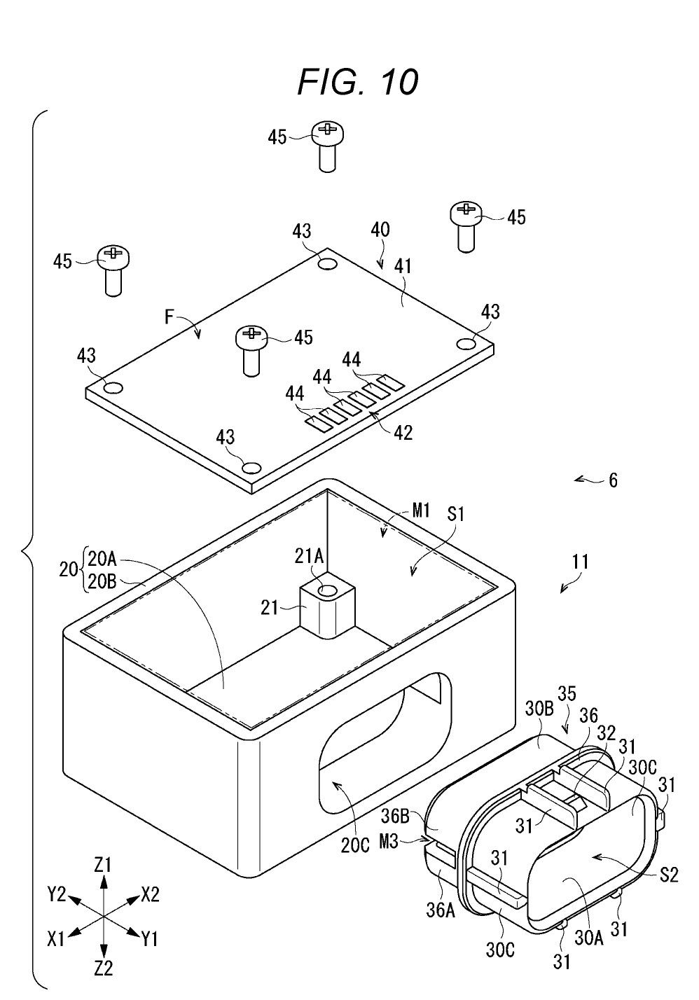

Next, other embodiments and modifications will be described with reference to FIGS. 10-18. Note that in the following description, the same reference numerals are used to represent components similar to those of the board case 10, the card edge board device 5, and the card edge connection structure 1 (card edge connector 50) according to the first embodiment above and similar description thereof may be omitted.

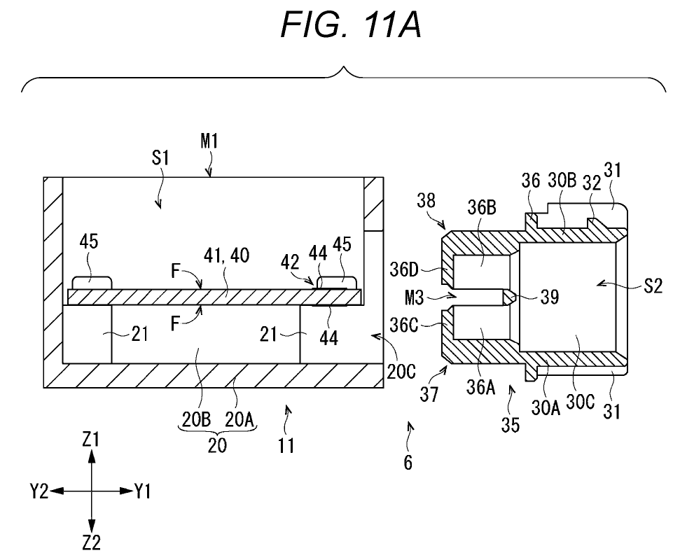

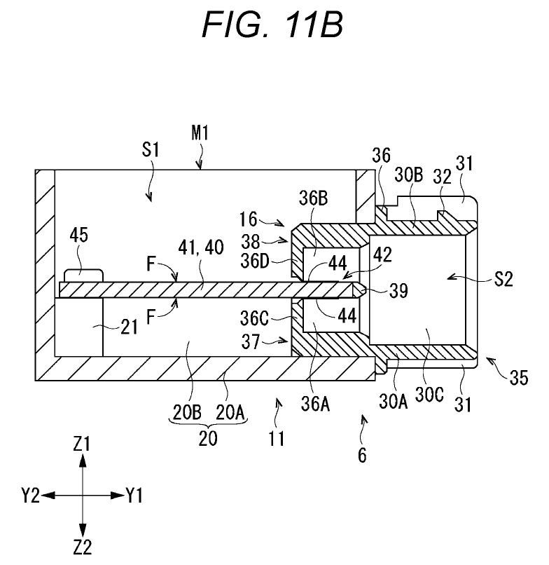

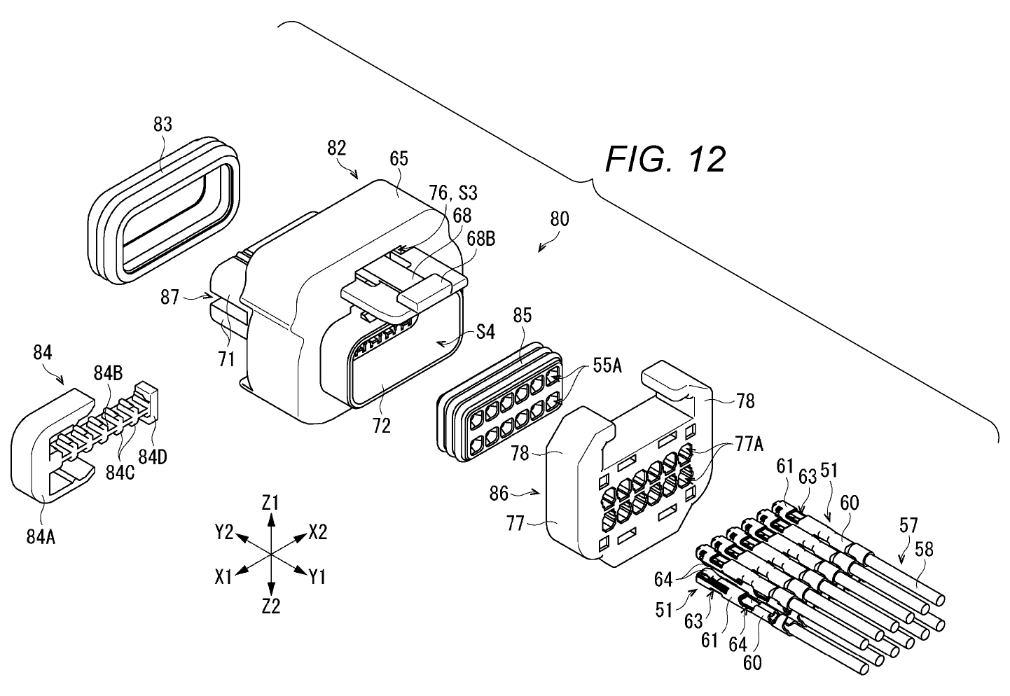

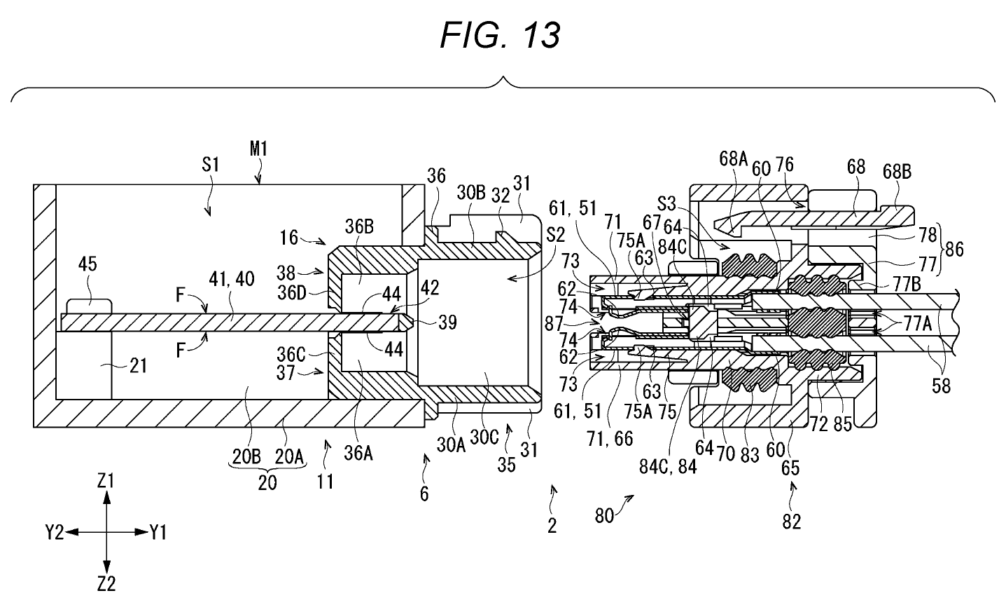

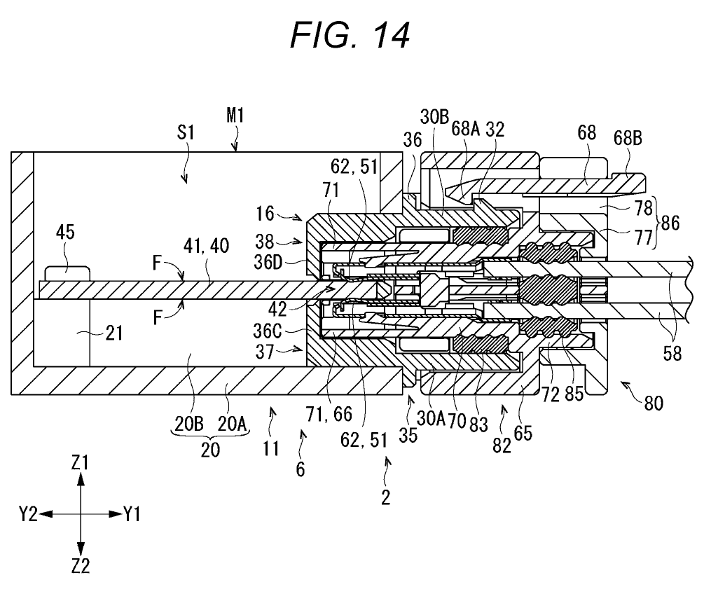

FIG. 10 is an exploded perspective view showing a card edge board device 6 according to a second embodiment. FIG. 11A is an exploded sectional view showing the card edge board device 6 according to the second embodiment. FIG. 11B is a sectional view showing the card edge board device 6 according to the second embodiment. FIG. 12 is an exploded perspective view showing a card edge connector 80 according to the second embodiment. FIG. 13 is a sectional view showing a card edge connection structure 2 (before connection) according to the second embodiment. FIG. 14 is a sectional view showing the card edge connection structure 2 (after connection) according to the second embodiment.

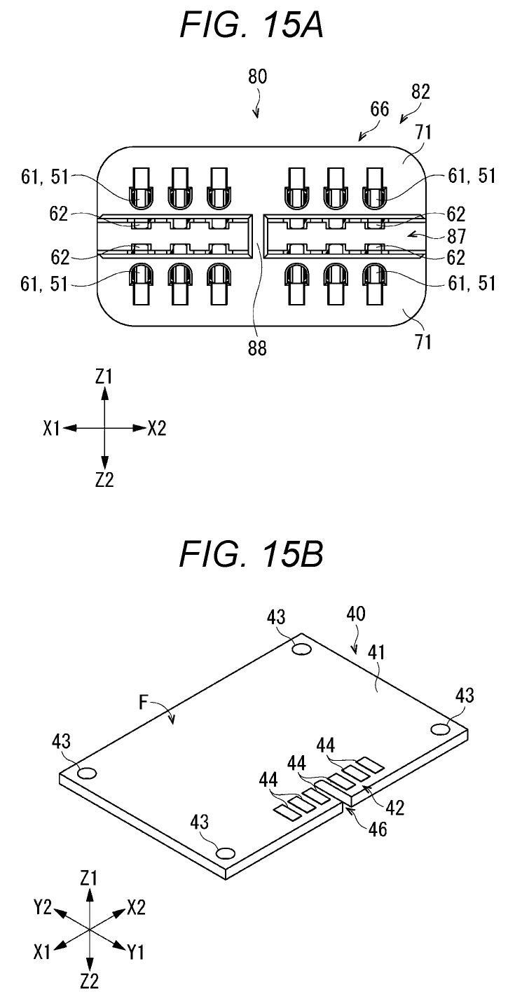

FIG. 15A is a front view schematically showing part of the card edge connector 80 according to a modification of the second embodiment. FIG. 15B is a perspective view showing the card edge board 40 of the card edge board device 6 according to the modification of the second embodiment.

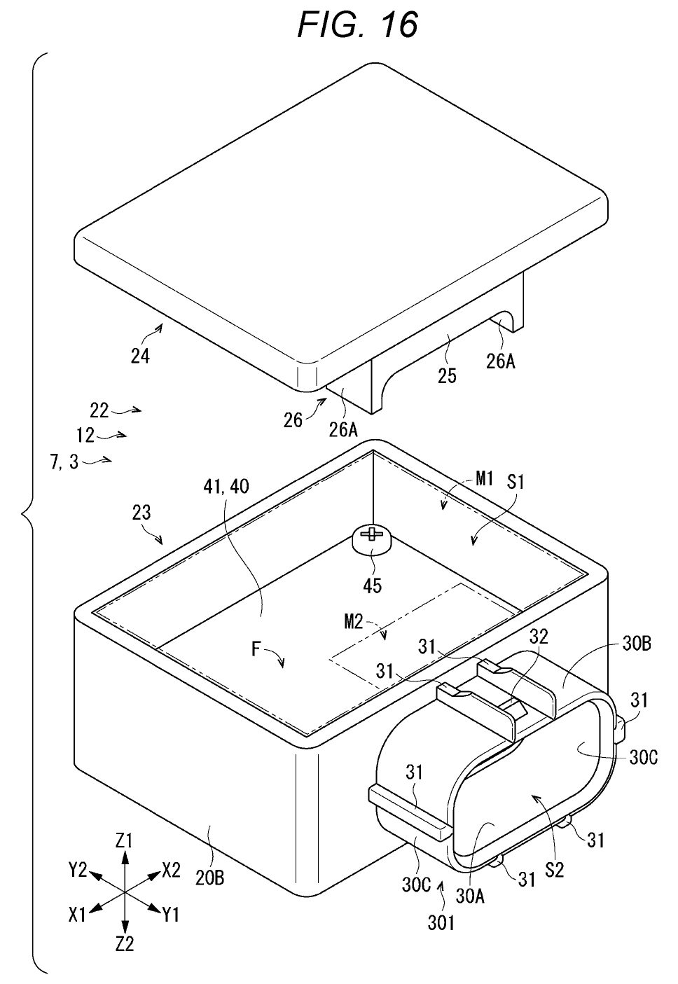

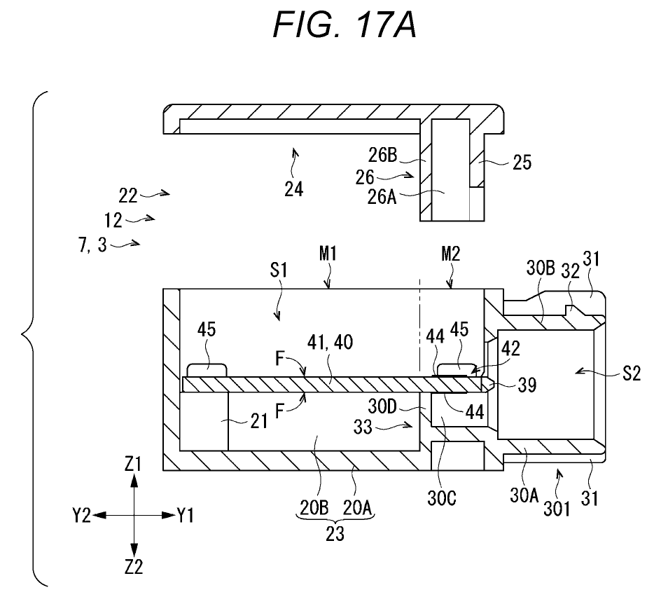

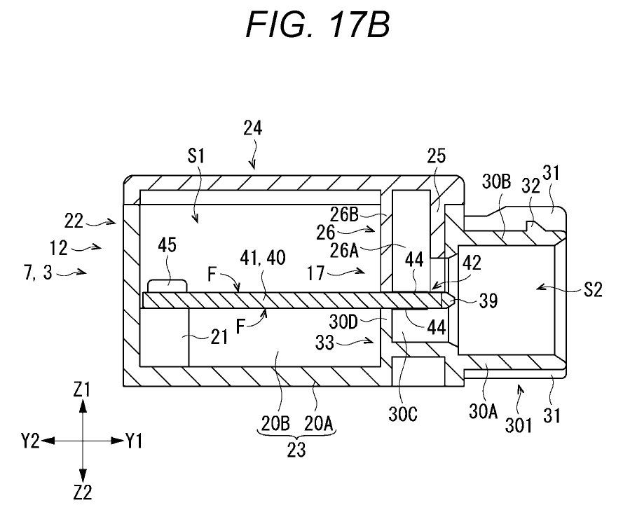

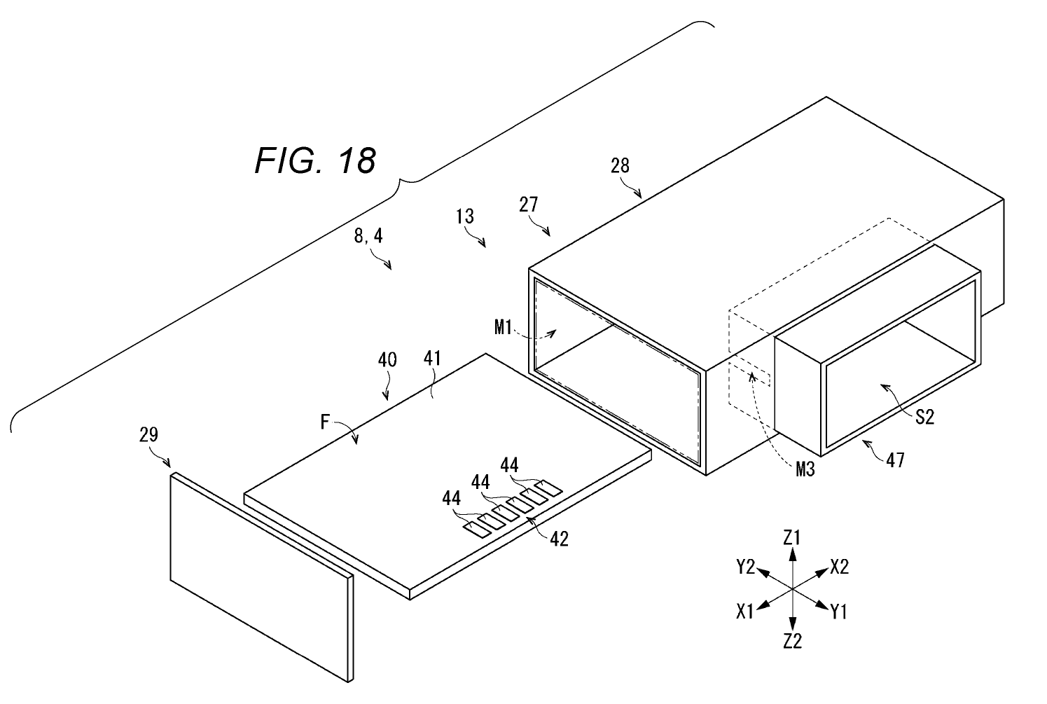

FIG. 16 is an exploded perspective view showing a card edge board device 7 according to a third embodiment. FIG. 17A is an exploded sectional view showing the card edge board device 7 according to the third embodiment. FIG. 17B is a sectional view showing the card edge board device 7 according to the third embodiment. FIG. 18 is an exploded perspective view schematically showing a card edge board device 8 according to a fourth embodiment.

### Second Embodiment

As shown in FIGS. 10 and 11A, in a board case 11 of the card edge connection structure 2 (card edge board device 6) according to the second embodiment, a fitting tubular body 35 is separated from the case body 20, and is attached to the case body 20. The fitting tubular body 35 is made of metal or synthetic resin, and is formed in a tubular shape having a rectangular section long in the left-right direction with rounded corners, for example. The outer peripheral surface of the fitting tubular body 35 is formed with a tubular body flange 36 which protrudes outward in the radial direction. The tubular body flange 36 is provided in the vicinity of the center of the fitting tubular body 35 in the front-rear direction.

The fitting tubular body 35 (rear portion of the fitting tubular body 35) located rearward of the tubular body flange 36 is inserted into an attachment opening 20C opened in the front of the case body 20 (rectangular peripheral wall 20B), and is disposed inside the case body 20 (housing space S1). Each tube side wall 30C forming the rear portion of the fitting tubular body 35 is divided into a lower side wall 36A and an upper side wall 36B by a slit-shaped contact passing opening M3 which is a cut formed in a center portion in the up-down direction. A lower end wall 36C is coupled to the rear end of the tube bottom wall 30A and the rear ends of the pair of lower side walls 36A, and an upper end wall 36D is coupled to the rear end of the tube top wall 30B and the rear ends of the pair of upper side walls 36B.

The rear portion of the tube bottom wall 30A, the pair of lower side walls 36A, and the lower end wall 36C forms a first partition 37. A rear portion of the tube top wall 30B, the pair of upper side walls 36B, and the upper end wall 36D form a second partition 38. The first partition 37 and the second partition 38 are disposed so as to face each other in the up-down direction with the slit-shaped contact passing opening M3 interposed therebetween. The fitting tubular body 35 has the slit-shaped contact passing opening M3 through which the contact 42 passes in part (rear portion) of the fitting tubular body 35 located in the housing space S1. The contact passing opening M3 extends forward from the rear, and is formed such that the contact 42 of the card edge board 40 is passable therethrough. A contact bar 39 is bridged between the pair of tube side walls 30C at the tip end of the contact passing opening M3. A front corner portion of the contact bar 39 is diagonally chamfered.

Note that similarly to the fitting tubular body 30 of the board case 10 according to the first embodiment, the fitting tubular body 35 (front portion of the fitting tubular body 35) located forward of the tubular body flange 36 is formed with the plurality of fitting protrusions 31. In the board case 11 according to the second embodiment, the engagement claw 32 is formed on the outer surface (upper surface) of the tube top wall 30B. In the card edge board device 6 according to the second embodiment, the contacts 42 (plurality of electrode patterns 44) of the card edge board 40 are formed on both the front and back surfaces of the end portion of the board body 41.

### Steps of Assembling Card Edge Board Device according to Second Embodiment

One example of steps of assembling the card edge board device 6 according to the second embodiment will be described. First, similarly to the steps of assembling the card edge board device 5 according to the first embodiment, the card edge board 40 (board body 41) passes through the board passing opening M1 while maintaining the horizontal posture, is housed in the case body 20 (housing space S1) while maintaining the posture at the time of passage, and is fixed to each board fixing portion 21 with the screw 45 (see FIG. 11A).

After the board body 41 has been housed in the housing space S1 of the case body 20, the fitting tubular body 35 separated from the case body 20 is attached to the case body 20. Specifically, the rear portion of the fitting tubular body 35 is inserted into the attachment opening 20C of the case body 20. When the fitting tubular body 35 is further inserted, the front end portion (contacts 42) of the board body 41 relatively enters the contact passing opening M3 of the fitting tubular body 35 (see FIG. 11B). Since the tubular body flange 36 contacts a front edge portion of the attachment opening 20C, insertion of the fitting tubular body 35 into the case body 20 is restricted (see FIG. 11B). Note that the fitting tubular body 35 (tubular body flange 36) may be fixed to the case body 20 with an adhesive. The front end surface (contacts 42) of the card edge board 40 abuts on the rear end surface of the contact bar 39.

As shown in FIG. 11B, the contacts 42 of the card edge board 40 pass through the contact passing opening M3, and are disposed in the fitting space S2 as part (rear portion) of the fitting tubular body 35 located in the housing space S1 while maintaining the posture at the time of passage. The upper end surface of the first partition 37 contacts the lower surface (principal surface F) of the board body 41, and the lower end surface of the second partition 38 contacts the upper surface (principal surface F) of the board body 41. The first partition 37 and the second partition 38 form a partition structure 16 sandwiching the board body 41 from both the upper and lower sides, contacting both the front and back surfaces of the board body 41, and dividing the housing space S1 and the fitting space S2 from each other.

Finally, as necessary, the case body 20 (housing space S1) is filled with the potting material. As described above, the card edge board device 6 is completed.

According to the board case 11 according to the second embodiment as described above, since the fitting tubular body 35 is separated from the case body 20, the fitting tubular body 35 can be attached to the case body 20, for example, after the card edge board 40 has been housed in the case body 20. With this configuration, a process of housing the card edge board 40 in the board case 11 (case body 20) can be further facilitated.

Next, the card edge connector 80 according to the second embodiment will be described. The card edge connector 80 is a waterproof connector having a structure similar to that of the card edge connector 50 according to the first embodiment. As shown in FIG. 12, the card edge connector 80 includes the plurality of terminals 51 (for example, 12 terminals), a housing 82, a housing seal 83, a retainer 84, a wire seal 85, and a seal cover 86.

Note that the 12 terminals 51 are arrayed in a matrix of two rows and six columns as viewed from the rear (or the front). That is, six terminals 51 arranged in the left-right direction are disposed in each of two upper and lower lines. The housing 82, the housing seal 83, the retainer 84, the wire seal 85, and the seal cover 86 are each components similar to the corresponding elements of the card edge connector 50 according to the first embodiment, and therefore, differences from the card edge connector 50 according to the first embodiment will be briefly described below.

As shown in FIGS. 12 and 13, the housing 82 has the outer tube portion 65, the inner tube portion 66, the holding attachment hole 67, and the lock arm 68, and for example, is integrally molded of non-conductive synthetic resin. A rear portion of the inner tube portion 66 is formed with a pair of contact housings 71 facing each other in the up-down direction with a board entrance groove 87 interposed therebetween. Although details will be described later, when the card edge connector 80 is fitted in the fitting tubular body 35, the front end portion (contacts 42) of the board body 41 enters the board entrance groove 87.

12 housing chambers 73 are arrayed in a matrix of two rows and six columns in the housing body 70 and pair of contact housings 71 of the inner tube portion 66. 12 contact holes 74 are opened in the opposing surfaces of the pair of contact housings 71 sandwiching the board entrance groove 87. The lance 75 protruding downward of the top surface and extending rearward is provided in the upper housing chamber 73. The lance 75 protruding upward of the bottom surface and extending rearward is provided in the lower housing chamber 73.

The holding attachment hole 67 is a through-hole penetrating the housing body 70 in the left-right direction, and is opened in the side surface of the housing body 70 protruding rearward of the outer tube portion 65 (not shown in FIG. 12). 12 holding holes (not shown) communicating with the 12 housing chambers 73 are opened in the top and bottom surfaces forming the holding attachment hole 67. The lock arm 68 is provided in an upper portion of the seal disposing space S3. The arm insertion hole 76 communicating with the seal disposing space S3 is opened in an upper portion of the front of the outer tube portion 65, and the lock arm 68 is swingably supported with the lower edge of the arm insertion hole 76 as the point of support. The lock claw 68A protrudes from a rear end portion of the lower surface of the lock arm 68, and the disengagement portion 68B is provided at a front end portion of the upper surface of the lock arm 68.

The housing seal 83 is formed in an annular shape from an elastically-deformable material, is disposed in the seal disposing space S3, and closely contacts the outer peripheral surface of the housing body 70 while crushing the projections on the inner peripheral surface. The retainer 84 is integrally molded of non-conductive synthetic resin, for example. The retainer 84 has a holding exterior portion 84A formed in a horizontally-oriented U-shape, a holding body 84B extending rightward of the holding exterior portion 54A, and 12 holding projections 84C protruding from both the upper and lower surfaces of the holding body 84B. A right end portion of the holding body 84B is formed with a plate-shaped holding flange 84D extending in the up-down direction.

The wire seal 85 is formed in a rectangular parallelepiped shape from an elastically-deformable material, and is formed fittable in the seal press-fitting space S4 of the seal housing 72. The wire seal 85 is formed with 12 seal through-holes 55A through which 12 cables 58 penetrate and which are arrayed in two rows and six columns. The seal cover 86 is integrally molded of non-conductive synthetic resin, for example. The front wall of the cover body 77 is formed with 12 cover through-holes 77A through which the 12 cables 58 penetrate and which are arrayed in two rows and six columns. The pair of cover arms 78 extends upward of both sides of the cover body 77 in the left-right direction, and is then bent in a direction of the cover arms 78 approaching each other.

The card edge connector 80 according to the second embodiment is assembled in steps similar to those of the card edge connector 50 according to the first embodiment. As shown in FIG. 13, the terminal contact 62 of the terminal 51 protrudes to the board entrance groove 87 from the contact hole 74 of the contact housing 71 in a state of the card edge connector 80 being assembled. The retainer 84 is inserted rightward into the holding attachment hole 67 from the left. Each holding projection 84C protrudes into the housing chamber 73 from the holding hole, and is fitted in the holding gap 64 of the terminal 51. Note that the holding exterior portion 84A and holding flange 84D of the retainer 84 form part of the exterior (both the right and left surfaces) of the housing body 70.

The card edge connector 80 according to the second embodiment is connected to the card edge board device 6 in steps similar to those of the card edge connector 50 according to the first embodiment. As shown in FIG. 14, when the card edge connector 80 is inserted into the fitting tubular body 35, the contacts 42 of the card edge board 40 relatively enter the board entrance groove 87 of the housing 82, and contact the plurality of terminal contacts 62 protruding to the board entrance groove 87 from the opposing surfaces of the pair of contact housings 71. When the card edge connector 80 is further inserted, the contacts 42 enter between the terminal contacts 62 facing each other in the up-down direction while opening, in the up-down direction, the terminal contacts 62 facing each other in the up-down direction. The terminal contacts 62 facing each other in the up-down direction sandwich the contacts 42 having entered the board entrance groove 87, and contact the contacts 42 (electrode patterns 44) on both the front and back surfaces.

As described above, the card edge connector 80 is connected to the card edge board device 6. In this state, the tip end surfaces (rear end surfaces) of the pair of contact housings 71 abut on the front of the lower end wall 36C and the front of the upper end wall 36D (or face these fronts with a slight gap therebetween).

According to the card edge connection structure 2 of the second embodiment as described above, effects similar to those of the card edge connection structure 1 according to the first embodiment, such as an effect of omitting the process of fixing the partner housing to the board body 41, can be obtained.

### Modification of Second Embodiment

As shown in FIG. 15A, in the modification of the second embodiment, the housing 82 of the card edge connector 80 has a rib 88 bridged between the pair of contact housings 71. The rib 88 is provided in a standing posture at the center of the board entrance groove 87 in the left-right direction, and couples the pair of contact housings 71. The board entrance groove 87 is divided in half in the left-right direction by the rib 88.

As shown in FIG. 15B, in the modification of the second embodiment, a cutout 46 is formed in the front end portion of the board body 41. The cutout 46 is recessed rearward of the front end at the center of the board body 41 in the left-right direction. The contacts 42 are divided in half in the left-right direction by the cutout 46. The rib 88 is fitted in the cutout 46 when the card edge connector 80 is fitted in the fitting tubular body 35.

According to the card edge connection structure 2 of the modification of the second embodiment, the rib 88 couples the pair of contact housings 71. Thus, separation or approaching of the pair of contact housings 71 can be reduced, and the pair of contact housings 71 can be maintained with a predetermined interval. With this configuration, the interval between the plurality of terminals 51 housed in the pair of contact housings 71 is also constant, and therefore, the terminals 51 (terminal contacts 62) can contact the contacts 42 on both the front and back surfaces of the card edge board 40 with proper pressure. When the card edge connector 80 is fitted in the fitting tubular body 35, the rib 88 is fitted in the cutout 46, and therefore, vibration of the card edge connector 80 along the left-right direction can be reduced. Since the pair of contact housings 71 is coupled by the rib 88, the stiffness of the entirety of the housing 82 is improved, and therefore, vibration of the card edge connector 80 along the up-down direction in a state of the end portion (contacts 42) of the card edge board 40 being sandwiched by the board entrance groove 87 can also be reduced.

Note that in the modification of the second embodiment, the one rib 88 is bridged between the pair of contact housings 71 at the center in the left-right direction, but the present disclosure is not limited thereto. The number of ribs 88 and the positions thereof may be freely changed. In this case, the number of cutouts 46 of the board body 41 and the positions thereof may also be changed in accordance with the number of ribs 88 and the positions thereof.

### Third Embodiment

As shown in FIGS. 16 and 17A, in a board case 12 of a card edge connection structure 3 (card edge board device 7) according to the third embodiment, a case body 22 is formed dividable in the up-down direction. Specifically, the case body 22 is formed dividable into a first divided case 23 and a second divided case 24. Note that the first divided case 23 has the substantially same structure as that of the case body 20 of the board case 10 according to the first embodiment, and therefore, detailed description thereof will be omitted.

A fitting tubular body 301 is provided integrally with the first divided case 23. The fitting tubular body 301 has the substantially same structure as that of the fitting tubular body 30 of the board case 10 according to the first embodiment, and in part (rear portion) of the fitting tubular body 301 located in the housing space S1, has the contact passing opening M2 through which the contact 42 passes. Note that in the fitting tubular body 301, the second partition 34 provided for the fitting tubular body 30 in the first embodiment is omitted. The engagement claw 32 provided on the tube bottom wall 30A of the fitting tubular body 30 in the first embodiment is provided on the tube top wall 30B of the fitting tubular body 301. In the fitting tubular body 301, the contact bar 39 on which the front end surface of the card edge board 40 (contact 42) abuts is bridged between the pair of tube side walls 30C.

Note that in the card edge board device 7 according to the third embodiment, the contacts 42 (plurality of electrode patterns 44) of the card edge board 40 are formed on both the front and back surfaces of the end portion of the board body 41, similarly to the card edge board device 6 according to the second embodiment.

The second divided case 24 is formed as a whole in a shallow tray shape opened in the lower surface. An inner wall 25 and a second partition 26 are provided in the vicinity of the center in the left-right direction (position corresponding to the fitting tubular body 301) at a front portion of the second divided case 24. The inner wall 25 suspends from a front end portion of the second divided case 24. The lower edge of the inner wall 25 is formed in an arch shape as viewed from the front. The second partition 26 is disposed on the rear side of the inner wall 25, and suspends from the top surface of the second divided case 24. The second partition 26 has a pair of partition side walls 26A extending rearward of both ends of the inner wall 25 in the left-right direction, and a partition end wall 26B bridged between the rear ends of the pair of partition side walls 26A. The partition side wall 26A and the partition end wall 26B extend downward of the inner wall 25.

When the card edge board device 7 according to the third embodiment is assembled, the card edge board 40 is housed in the first divided case 23 in a manner similar to that of the card edge board device 5 according to the first embodiment. That is, the first divided case 23 supports the board body 41 having passed through the board passing opening M1 in the horizontal posture (posture of the principal surface F being parallel to the one surface having the board passing opening M1) while maintaining the horizontal posture. The contacts 42 pass through the contact passing opening M2, and are disposed in the fitting space S2 as part of the fitting tubular body 301 located in the housing space S1 while maintaining the posture at the time of passage (see FIG. 17A).

Next, the second divided case 24 is disposed above the first divided case 23 (see FIG. 17A), moves downward while maintaining the horizontal posture, and is disposed with the board body 41 interposed between the second divided case 24 and the first divided case 23. The second divided case 24 closes the board passing opening M1, and the first divided case 23 and the second divided case 24 are connected to form the case body 22 (see FIG. 17B). Note that the second divided case 24 may be fixed to the first divided case 23 with an adhesive. The inner wall 25 overlaps with the inner surface of the front wall of the first divided case 23, and the lower end of the inner wall 25 is located slightly lower than the tube top wall 30B of the fitting tubular body 301.

As shown in FIG. 17B, the upper end surface of the first partition 33 contacts the lower surface (principal surface F) of the board body 41, and the lower end surface of the second partition 26 contacts the upper surface (principal surface F) of the board body 41. The second partition 26 contacts the upper surface (principal surface F) of the board body 41 to close the fitting space S2. In the present embodiment, the lower surface of the board body 41 is the principal surface F on the first divided case 23 side, and the upper surface of the board body 41 is the principal surface F on the second divided case 24 side. The first partition 33 and the second partition 26 form a partition structure 17 sandwiching the board body 41 from both the upper and lower sides and dividing the housing space S1 and the fitting space S2 from each other.

Note that although not shown in the figure, the card edge connector 80 according to the second embodiment is connected to the card edge board device 7 (card edge board 40) according to the third embodiment.

According to the board case 12 of the third embodiment, the card edge board 40 (board body 41 and contacts 42) can be housed in the first divided case 23 and the fitting tubular body 301 while maintaining the posture parallel to the upper surface of the first divided case 23. With this configuration, it is not necessary to incline the card edge board 40 or change the posture thereof, and effects similar to those of the board case 10 according to the first embodiment, such as an effect of easily housing the card edge board 40 in the board case 12, can be obtained.

Note that the features of the board case 11 according to the second embodiment including the modification thereof may be applied to the board case 12 according to the third embodiment and the fitting tubular body 301 may be separatable from the first divided case 23 (not shown). In this case, the first partition 33 of the first divided case 23, the inner wall 25 and second partition 26 of the second divided case 24, and the like may be omitted (not shown).

### Fourth Embodiment

As shown in FIG. 18, in a card edge connection structure 4 (card edge board device 8) according to the fourth embodiment, a case body 27 of a board case 13 is dividable in the left-right direction. The case body 27 is formed dividable into a first divided case 28 and a second divided case 29.

The first divided case 28 is formed in a box shape including one surface with the board passing opening M1. In the present embodiment, the board passing opening M1 is provided in the left surface of the first divided case 28.

The first divided case 28 supports the board body 41 having passed through the board passing opening M1 in the horizontal posture (posture of the principal surface F being perpendicular to the left surface which is the one surface having the board passing opening M1) while maintaining the posture at the time of passage. The second divided case 29 is formed, for example, in a substantially plate shape, is disposed with the board body 41 sandwiched between the second divided case 29 and the first divided case 28, and closes the board passing opening M1. Note that although not shown in the figure, the first divided case 28 may be provided with a structure for supporting (fixing) the board body 41.

A fitting tubular body 47 is provided integrally with the first divided case 28. The fitting tubular body 47 has the substantially same structure as that of the fitting tubular body 35 of the board case 10 according to the second embodiment, and in part (rear portion) of the fitting tubular body 47 located in the housing space S1, has the slit-shaped contact passing opening M3 through which the contact 42 passes. The contact 42 is disposed in the fitting space S2 as part of the fitting tubular body 47 located in the housing space S1 while maintaining the posture at the time of passage through the contact passing opening M3.

According to the board case 13 of the fourth embodiment, effects similar to those of the board case 10 according to the first embodiment, such as an effect of easily housing the card edge board 40, can be obtained. Note that the features of the board case 11 according to the second embodiment may be applied to the board case 13 according to the fourth embodiment, and the fitting tubular body 47 may be separatable from the first divided case 28 (not shown).

In the first embodiment, the case body 20 includes the one surface (upper surface) having the board passing opening M1. The board passing opening M1 is formed such that when the card edge board 40 is housed in the board case 10, the board body 41 is passable through the board passing opening M1 in the posture of the principal surface F being parallel to the one surface. The contact passing opening M2 is formed in part of the fitting tubular body 30 located in the housing space, and is formed such that when the card edge board 40 is housed in the board case 10, the contact 42 is passable through the contact passing opening M2.

In the second embodiment, the case body 20 includes the one surface (upper surface) having the board passing opening M1. The board passing opening M1 is formed such that when the card edge board 40 is housed in the board case 10, the board body 41 is passable through the board passing opening M1 in the posture of the principal surface F being parallel to the one surface. The contact passing opening M3 is formed in the slit shape in part of the fitting tubular body 35 located in the housing space S1, and is formed such that when the fitting tubular body 35 separated from the case body 20 is attached to the case body 20, the contacts 42 are passable through the contact passing opening M3.

In the third embodiment, the first divided case 23 includes the one surface (upper surface) having the board passing opening M1. The board passing opening M1 is formed such that when the card edge board 40 is housed in the board case 12, the board body 41 is passable through the board passing opening M1 in the posture of the principal surface F being parallel to the one surface. The contact passing opening M2 is formed in part of the fitting tubular body 301 located in the housing space S1, and is formed such that when the card edge board 40 is housed in the board case 12, the contacts 42 are passable through the contact passing opening M2.

In the fourth embodiment, the first divided case 28 includes the one surface (left surface) having the board passing opening M1. The board passing opening M1 is formed such that when the card edge board 40 is housed in the board case 13, the board body 41 is passable through the board passing opening M1 in the posture of the principal surface F being perpendicular to the one surface. The contact passing opening M3 is formed in the slit shape in part of the fitting tubular body 47 located in the housing space S1, and is formed such that when the card edge board 40 is housed in the board case 13, the contact 42 is passable through the contact passing opening M3. For example, in the present disclosure, the board passing opening is formed such that when the card edge board is housed in the board case, the board body is passable through the board passing opening in the posture of the principal surface being parallel or perpendicular to the one surface having the board passing opening. The board body is supported by the case body while maintaining any one of the postures at the time of passage through the board passing opening. Part of the fitting tubular body located in the housing space has the contact passing opening formed such that the contact is passable therethrough, and the contact is disposed (housed) in the fitting space as part of the fitting tubular body while maintaining the posture at the time of passage through the contact passing opening.

Note that in the board cases 10 to 13 according to the first to fourth embodiments, the partition structures 15 to 17 dividing the housing space S1 and the fitting space S2 from each other are provided, but the present disclosure is not limited thereto and the partition structures 15 to 17 may be omitted (not shown).

In the card edge connection structures 1 to 4 according to the first to fourth embodiments, the card edge connector 50 is the waterproof connector, but the present disclosure is not limited thereto and the card edge connector 50 may be a non-waterproof connector (not shown).

Note that the embodiments above only describe one aspect of the board case, the card edge board device, and the card edge connection structure according to the present disclosure and the technical scope of the present disclosure is not limited to the embodiments above. The components in the embodiments above may be replaced or combined with existing components or the like as necessary, and the description of the embodiments above does not limit the contents of the disclosure described in the claims.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A board case for housing a card edge board having a contact at an end portion of a board body, comprising:
a case body forming a housing space in which the board body is housable; and
a fitting tubular body forming a fitting space in which the contact of the card edge board is housable and a card edge connector connected to the card edge board is fittable,
wherein the fitting tubular body is formed in a tubular shape having an opening opened along a direction parallel to a principal surface of the card edge board housed in the board case and extending outward of an inside of the housing space,
the case body is formed in a box shape including one surface having a board passing opening, the board passing opening is formed such that when the card edge board is housed in the board case, the board body is passable through the board passing opening in a posture of the principal surface being parallel to the one surface, and the board body is supported by the case body while maintaining the posture at a time of passage through the board passing opening, and
part of the fitting tubular body located in the housing space has a contact passing opening formed such that the contact is passable therethrough, and the contact is disposed in the fitting space as the part of the fitting tubular body while maintaining a posture at a time of passage through the contact passing opening.

2. A board case for housing a card edge board having a contact at an end portion of a board body, comprising:
a case body forming a housing space in which the board body is housable; and
a fitting tubular body forming a fitting space in which the contact of the card edge board is housable and a card edge connector connected to the card edge board is fittable,
wherein the fitting tubular body is formed in a tubular shape having an opening opened along a direction parallel to a principal surface of the card edge board housed in the board case and extending outward of an inside of the housing space,
the case body is formed dividable into a first divided case and a second divided case,
the first divided case is formed in a box shape including one surface having a board passing opening, the board passing opening is formed such that when the card edge board is housed in the board case, the board body is passable through the board passing opening in a posture of the principal surface being parallel to the one surface or a posture of the principal surface being perpendicular to the one surface, and the board body is supported by the first divided case while maintaining any one of the postures at a time of passage through the board passing opening,
the second divided case is disposed with the board body interposed between the second divided case and the first divided case, and closes the board passing opening,
the fitting tubular body is provided in the first divided case, and
part of the fitting tubular body located in the housing space has a contact passing opening formed such that the contact is passable therethrough, and the contact is disposed in the fitting space as the part of the fitting tubular body while maintaining a posture at a time of passage through the contact passing opening.

3. The board case according to claim 1, wherein
the fitting tubular body is separated from the case body, and is attached to the case body.

4. The board case according to claim 3, wherein
the fitting tubular body is attached to the case body after the board body has been housed in the housing space, and
the fitting tubular body has a partition structure dividing the housing space and the fitting space from each other, and the partition structure is configured to contact both front and back surfaces of the board body.

5. The board case according to claim 1, wherein
the fitting tubular body has a partition structure dividing the housing space and the fitting space from each other, and the partition structure is configured to contact the principal surface of the board body opposite to the contact passing opening and an end surface of the board body facing the opening of the fitting tubular body.

6. The board case according to claim 2, wherein
the board body is supported by the first divided case in a posture of the principal surface being parallel to the one surface of the first divided case,
the fitting tubular body is provided with a first partition which contacts the principal surface on a first divided case side among both back and front surfaces of the board body,
the second divided case is provided with a second partition which contacts the principal surface on a second divided case side among both the back and front surfaces of the board body to close the fitting space, and
the first partition and the second partition form a partition structure dividing the housing space and the fitting space from each other.

7. A card edge board device comprising:
the board case according to claim 1; and
the card edge board housed in the board case.

8. A card edge board device comprising:
the board case according to claim 2; and
the card edge board housed in the board case.

9. A card edge connection structure comprising:
the card edge board device according to claim 7; and
the card edge connector connected to the card edge board.

10. A card edge connection structure comprising:
the card edge board device according to claim 8; and
the card edge connector connected to the card edge board.

11. The card edge connection structure according to claim 9, wherein
the contact of the card edge board includes contacts provided on both front and back surfaces of the end portion of the board body,
the card edge connector has a housing including a pair of contact housings and a board entrance groove, and a plurality of terminals,
the board entrance groove is configured such that when the card edge connector is fitted in the fitting tubular body, the end portion of the board body enters the board entrance groove, and the pair of contact housings faces each other with the board entrance groove therebetween,
the plurality of terminals is housed in the housing, sandwiches the end portion having entered the board entrance groove, and contacts the contacts provided on both the front and back surfaces of the end portion of the board body,
the housing has a rib bridged between the pair of contact housings, and
the end portion of the board body is formed with a cutout in which the rib is fitted when the card edge connector is fitted in the fitting tubular body.

12. The card edge connection structure according to claim 10, wherein
the contact of the card edge board includes contacts provided on both front and back surfaces of the end portion of the board body,
the card edge connector has a housing including a pair of contact housings and a board entrance groove, and a plurality of terminals,
the board entrance groove is configured such that when the card edge connector is fitted in the fitting tubular body, the end portion of the board body enters the board entrance groove, and the pair of contact housings faces each other with the board entrance groove therebetween,
the plurality of terminals is housed in the housing, sandwiches the end portion having entered the board entrance groove, and contacts the contacts provided on both the front and back surfaces of the end portion of the board body,
the housing has a rib bridged between the pair of contact housings, and
the end portion of the board body is formed with a cutout in which the rib is fitted when the card edge connector is fitted in the fitting tubular body.
